(19) United States
(12) Patent Application Publication
(10) Pub. No.: US 2025/0155674 A1
(43) Pub. Date: May 15, 2025

(54) IMAGING LENS SYSTEM

(71) Applicant: SAMSUNG ELECTRO-MECHANICS CO., LTD., Suwon-si (KR)

(72) Inventors: Kum Ho KIM, Suwon-si (KR); Byung Hyun KIM, Suwon-si (KR); Tae Yeon LIM, Suwon-si (KR)

(73) Assignee: SAMSUNG ELECTRO-MECHANICS CO., LTD., Suwon-si (KR)

(21) Appl. No.: 18/815,963

(22) Filed: Aug. 27, 2024

(30) Foreign Application Priority Data
Nov. 9, 2023 (KR) 10-2023-0154657

(51) Int. Cl. G02B 9/10; G02B 13/18

(52) U.S. Cl. CPC G02B 9/10; G02B 13/18

(57) ABSTRACT

An imaging lens system is provided. The imaging lens system includes a first lens group including one or more lenses, and a second lens group including one or more lenses and configured to be movable in an optical axis direction. The first lens group and the second lens group are sequentially arranged from an object side toward an imaging plane. The imaging lens system satisfies the conditional expression TTL/(ImgHT*2)<0.850, where TTL is a distance from an object-side surface of a foremost lens disposed closest to an object, to the imaging plane, and ImgHT is a height of the imaging plane.

### CROSS-REFERENCE TO RELATED APPLICATIONS

This application claims the benefit under 35 USC § 119 (a) of Korean Patent Application No. 10-2023-0154657 filed on Nov. 9, 2023, in the Korean Intellectual Property Office, the entire disclosure of which is incorporated herein by reference for all purposes.

### BACKGROUND

### 1. Field

The following description relates to an imaging lens system.

### 2. Description of Related Art

Portable electronic devices include a camera module that captures still images or recordings of a moving image.

For example, a camera module can be mounted on portable electronic devices such as, but not limited to, a mobile phone, a laptop, or the like, or a game console. Such portable electronic devices are generally manufactured in compact or small sizes to increase user convenience when carrying the devices. Therefore, the camera module mounted on the portable electronic device is configured to have a limited form factor of an imaging lens system. For example, a camera module includes imaging lens system with a fixed focal length. Accordingly, the imaging lens system of such a camera module may only capture images of subjects located within a specific range (for example, a near distance or a far distance), and it may difficult to capture images of subjects located outside of the range.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an imaging lens system includes a first lens group comprising one or more lenses; and a second lens group, comprising one or more lenses and configured to be movable in an optical axis direction, wherein the first lens group and the second lens group are arranged sequentially from an object side toward an imaging plane, and wherein the imaging lens system satisfies the following conditional expression: TTL/(ImgHT*2)<0.850, where TTL is a distance from an object-side surface of a foremost lens disposed closest to an object, to the imaging plane, and ImgHT is a height of the imaging plane.

The foremost lens may have a convex image-side surface.

A rear lens in the first lens group disposed closest to the second lens group may have a convex image-side surface.

A front lens in the second lens group disposed closest to the first lens group may have a concave object-side surface.

A rearmost lens disposed closest to the imaging plane may have a concave image-side surface.

fG1/fG1F<1.10, where fG1 is a focal length of the first lens group, and fG1F is a focal length of the foremost lens.

fG2/fG2F<1.0, where fG2 is a focal length of the second lens group, and fG2F is a focal length of a lens disposed closest to the object in the second lens group.

fG1/f<0.550, where fG1 is a focal length of the first lens group, and f is a focal length of the imaging lens system.

In a general aspect, an imaging lens system includes a first lens, a second lens, a third lens, a fourth lens, a fifth lens, and a sixth lens, sequentially arranged from an object side toward an imaging plane, wherein the first lens has a convex image-side surface, and wherein −1.2<f1/f4<−0.40, where f1 is a focal length of the first lens and f4 is a focal length of the fourth lens. The first lens may have a convex object-side surface.

The second lens may have a concave image-side surface.

The third lens may have a convex object-side surface.

The fourth lens may have a concave object-side surface.

The fifth lens may have a convex image-side surface.

The imaging lens system may further include a seventh lens disposed on an image side of the sixth lens.

The seventh lens may have a concave image-side surface.

in a general aspect, an electronic device includes an imaging lens system including a first lens, a second lens, a third lens, a fourth lens, a fifth lens, and a sixth lens, sequentially arranged from an object side toward an imaging plane, wherein the imaging lens system satisfies the following conditional expression: TTL/(ImgHT*2)<0.850, where TTL is a distance from an object-side surface of a foremost lens disposed closest to an object, to the imaging plane, and ImgHT is a height of the imaging plane.

The imaging lens system may further include a seventh lens disposed on an image side of the sixth lens.

Other features and aspects will be apparent from the following detailed description, the drawings, and the claims.

### BRIEF DESCRIPTION OF DRAWINGS

FIG. 1 illustrates a configuration diagram of an example imaging lens system according to a first embodiment.

FIG. 2 illustrates an aberration curve of the example imaging lens system illustrated in FIG. 1.

FIG. 3 illustrates a configuration diagram of an example imaging lens system according to a second embodiment.

FIG. 4 illustrates an aberration curve of the example imaging lens system illustrated in FIG. 3.

FIG. 5 illustrates a configuration diagram of an example imaging lens system according to a third embodiment.

FIG. 6 illustrates an aberration curve of the example imaging lens system illustrated in FIG. 5.

FIG. 7 illustrates a configuration diagram of an example imaging lens system according to a fourth embodiment.

FIG. 8 illustrates an aberration curve of the example imaging lens system illustrated in FIG. 7.

FIG. 9 illustrates a configuration diagram of an example imaging lens system according to a fifth embodiment.

FIG. 10 illustrates an aberration curve of the example imaging lens system illustrated in FIG. 9.

FIG. 11 illustrates a configuration diagram of an example imaging lens system according to a sixth embodiment.

FIG. 12 illustrates an aberration curve of the example imaging lens system illustrated in FIG. 10.

FIG. 13 illustrates a configuration diagram of an example imaging lens system according to a seventh embodiment.

FIG. 14 illustrates an aberration curve of the example imaging lens system illustrated in FIG. 13.

FIG. 15 illustrates a configuration diagram of an example imaging lens system according to an eighth embodiment.

FIG. 16 illustrates an aberration curve of the example imaging lens system illustrated in FIG. 15.

FIG. 17 illustrates another form of an example imaging lens system according to the first to eighth embodiments.

FIG. 18 illustrates an example electronic device including an example imaging lens system according to the first to eighth embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide an imaging lens system that images and photographs subjects located at a distance near and far therefrom.

One or more examples may provide an imaging lens system configured to enable the capturing of images of subjects located at a relatively close distance, and not only subjects located at distant points.

One or more examples may provide an imaging lens system that captures and records images of subjects not only located at a distant point or location, but also subjects located at a close distance with high resolution.

In the one or more examples, a first lens refers to a lens most adjacent to an object (or a subject), and a sixth lens or a seventh lens refers to a lens most adjacent to an imaging plane (or an image sensor). In the one or more embodiments, units of a radius of curvature, a thickness, TTL (a distance from an object-side surface of the first lens to the imaging plane), an IMGHT (a height of the imaging plane), and a focal length are indicated in millimeters (mm).

A thickness of a lens, a gap between lenses, and a TTL refers to a distance of a lens along an optical axis, and specifically, a distance from an object-side surface of the first lens to the imaging plane. Also, in the descriptions of a shape of a lens, a configuration in which one surface is convex indicates that a paraxial region of the surface is convex, and a configuration in which one surface is concave indicates that a paraxial region of the surface is concave. Thus, even when it is described that one surface of a lens is convex, an edge of the lens may be concave. Similarly, even when it is described that one surface of a lens is concave, an edge of the lens may be convex.

An imaging lens system according to a first aspect embodiment may include two lens groups. For example, the imaging lens system according to the first aspect may include a first lens group and a second lens group sequentially arranged from an object side toward an imaging plane. The first lens group and the second lens group may respectively include one or more lenses. For example, the first lens group may be comprised of three lenses, and the second lens group may be comprised of three or four lenses. However, the number of lenses constituting the first lens group and the second lens group is not limited to the above-described form. The imaging lens system according to the first aspect may include a lens group movable in an optical axis direction. For example, the imaging lens system according to the first aspect, the second lens group may be configured to be movable in the optical axis direction. The imaging lens system according to the first aspect may satisfy a unique conditional expression. For example, the imaging lens system according to the first aspect may satisfy the conditional expressions TTL/(ImgHT*2)<0.850, where TTL is a distance from an object-side surface of a front lens disposed closest to an object to an imaging plane, and ImgHT is a height of an imaging plane.

The imaging lens system according to the first aspect may include a predetermined lens. For example, the imaging lens system according to the first aspect may include a lens having a convex image-side surface. For example, the imaging lens system according to the first aspect, the foremost lens may have a convex image-side surface. As another example, in the imaging lens system according to the first aspect, the lens closest to an imaging plane in the first lens group may have a convex image-side surface. The imaging lens system according to the first aspect may also include a lens with a concave image-side surface. For example, in the imaging lens system according to the first aspect, the lens closest to an object in the second lens group may have a concave object-side surface. As another example, in the imaging lens system according to the first aspect, the rearmost lens disposed closest to an imaging plane may have a concave image-side surface.

An imaging lens system according to a second aspect may include a first lens group and a second lens group sequentially arranged from an object side toward an imaging plane, and may include one or more lenses with convex image-sides surface. For example, in the imaging lens system according to the second aspect, the foremost lens disposed closest to an object may have a convex image-side surface. The imaging lens system according to the second aspect may be configured to satisfy a unique conditional expression. For example, the imaging lens system according to the second aspect may satisfy one or more of the following conditional expressions:

$$f / ( SD 1 * 2 ) < 1.9$$

$$0. 90 < \vert fG 1 / fG 2 \vert < 1.2$$

$$0.9 < TTL / f < 1 \text{.10}$$

$$\vert fG 22 / ( L - fG ) \vert / AF < 0 \text{.80}$$

$$TTL / ( ImgHT * 2 ) < 0 \text{.85}$$

$$fG 1 / fG 1 F < 1.1$$

$$fG 2 / fG 2 F < 1.$$

$$fG 1 / f < 0 \text{.55}$$

$$SD 1 / SD 7 < 2.0$$

In the above conditional expression, f is a focal length of an imaging lens system, SD1 is an effective radius of a foremost lens, fG1 is a focal length of the first lens group, fG2 is a focal length of the second lens group, L is a maximum proximity distance that an imaging lens system may capture (a distance from an object-side surface of a foremost lens to an object (or subject)), AF is a maximum driving distance of the second lens group, fG1F is a focal length of a foremost lens, fG2F is a focal length of a lens closest to an object in the second lens group, and SD7 is an effective radius of a lens closest to an object in the second lens group.

An imaging lens system according to a third aspect may include one or more of the first aspect and the second aspect, and may be configured to satisfy one or more of the following conditional expressions. As an example, the imaging lens system according to the third aspect may include a characteristics of the first aspect and satisfy one of the following conditional expressions. As another example, the imaging lens system according to the third aspect may include a characteristics of the second aspect and satisfy two or more of the following conditional expressions:

$$- 1.20 < fG 1 F / fG 2 F < - 0 \text{.40}$$

$$0.6 < fG 1 F / fG 1 R < 1.$$

$$0.3 < fG 2 F / fG 2 R < 1.$$

$$- 1.6 < fG 1 R / fG 2 F < - 0 \text{.80}$$

$$- 0.8 \; 0 < fG 1 R / fG 2 R < - 0.10$$

In the above conditional expression, fG1R is a focal length of a lens closest to an imaging plane in the first lens group, and fG2R is a focal length of a lens closest to an imaging plane in the second lens group.

An imaging lens system according to a fourth aspect includes a plurality of lenses arranged sequentially from an object side toward an imaging plane. As an example, the imaging lens system according to the fourth aspect may include a first lens, a second lens, a third lens, a fourth lens, a fifth lens, and a sixth lens, sequentially arranged from an object side toward an imaging plane. As another example, the imaging lens system according to the fourth aspect may include a first lens, a second lens, a third lens, a fourth lens, a fifth lens, a sixth lens, and a seventh lens, sequentially arranged from an object side toward an imaging plane. The imaging lens system according to the fourth aspect may include a convex image-side surface. For example, in the imaging lens system according to the fourth aspect, the first lens may have a convex image-side surface. The imaging lens system according to the fourth aspect may satisfy a unique conditional expression. As an example, the imaging lens system according to the fourth aspect may satisfy the conditional expression −1.20<f1/f4<−0.40. In the conditional expression, f1 is a focal length of the first lens, and f4 is a focal length of the fourth lens.

An imaging lens system according to a fifth aspect includes a plurality of lenses arranged sequentially from an object side toward an imaging plane, and may satisfy one or more of the following conditional expressions. As an example, the imaging lens system according to the fifth aspect includes a first lens, a second lens, a third lens, a fourth lens, a fifth lens, and a sixth lens arranged sequentially from an object side, and may satisfy one or more of the following conditional expressions. As another example, the imaging lens system according to the fifth aspect includes a first lens, a second lens, a third lens, a fourth lens, a fifth lens, a sixth lens, and a seventh lens arranged sequentially from an object side toward an imaging plane, and may satisfy one or more of the conditional expressions.

$$- 1.20 < f 1 / f 4 < - 0 \text{.40}$$

$$0. 60 < f 1 / f 3 < 1.$$

$$- 1.6 < f 3 / f 4 < - 0 \text{.80}$$

$$- 0.8 < f 3 / f 6 < - 0 \text{.30}$$

$$- 0.5 < f 3 / f 7 < - 0 \text{.20}$$

$$0.3 < f 4 / f 6 < 1.$$

$$0.3 < f 4 / f 7 < 0.40$$

In the above conditional expression, f1 is a focal length of a first lens, f2 is a focal length of a second lens, f3 is a focal length of a third lens, f4 is a focal length of a fourth lens, f5 is a focal length of a fifth lens, f6 is a focal length of a sixth lens, and f7 is a focal length of a seventh lens.

An imaging lens system according to a sixth aspect includes a plurality of lenses arranged sequentially from an object side toward an imaging plane, and may satisfy one or more of the following conditional expressions. As an example, the imaging lens system according to the sixth aspect includes a first lens, a second lens, a third lens, a fourth lens, a fifth lens, and a sixth lens arranged sequentially from an object side toward an imaging plane, and may satisfy one or more of the following conditional expressions. As another example, the imaging lens system according to the sixth aspect includes a first lens, a second lens, a third lens, a fourth lens, a fifth lens, a sixth lens, and a seventh lens arranged sequentially from an object side toward an imaging plane, and may satisfy one or more of the conditional expressions.

$$0.3 < R 1 / R 5 < 0 \text{.80}$$

$$- 0.8 < R 1 / R 6 < - 0 \text{.30}$$

$$- 1.4 < R 1 / R 7 < - 0 \text{.80}$$

$$- 2.1 < R 2 / R 5 < - 1.$$

$$1. < R 2 / R 6 < 2.$$

$$- 3. < R 5 / R 7 < - 1 \text{.20}$$

$$1.2 < R 6 / R 7 < 3.0$$

In the above conditional equation, R1 is a radius of curvature of an object-side surface of a first lens, R2 is a radius of curvature of an image-side surface of a first lens, R5 is a radius of curvature of an object-side surface of a third lens, R6 is a radius of curvature of an image-side surface of a third lens, and R7 is a radius of curvature of an object-side surface of a fourth lens. An imaging lens system according to a seventh aspect may be configured to include two or more of the features according to the first to sixth aspects. As an example, the imaging lens system according to the seventh aspect may include a characteristics of the first aspect and satisfy one or more of the conditional expressions according to the fifth aspect. As another example, the imaging lens system according to the seventh aspect may include a characteristics of the first aspect and satisfy one or more of the conditional expressions according to the sixth aspect.

An imaging lens system according to the present disclosure may include one or more lenses having the following characteristics as needed. As an example, the imaging lens system according to the first aspect may include one of the first to seventh lenses according to the following characteristics. As another example, the imaging lens system according to the second to fourth aspects may include one or more of the first to seventh lenses according to the following characteristics. However, the imaging lens system according to the above-described aspect does not necessarily include a lens according to the following characteristics. Below, the characteristics of the first to seventh lenses will be described.

The first lens may have refractive power. For example, the first lens may have positive refractive power. The first lens may have a convex shape on one surface. For example, the first lens may have a convex object-side surface. The first lens may include a spherical surface or aspherical surface. For example, both surfaces of the first lens may be aspherical. The first lens may be formed of a material having high light transmittance and excellent processability. For example, the first lens may be formed of a plastic material or glass. The first lens may be configured to have a high refractive index. For example, a refractive index of the first lens may be greater than 1.5. As a specific example, the refractive index of the first lens may be greater than 1.50 and less than 1.6. The first lens may have a predetermined Abbe number. For example, an Abbe number of the first lens may be 50 or more. As a specific example, the Abbe number of the first lens may be greater than 50 and less than 60.

The second lens may have refractive power. For example, the second lens may have negative refractive power. The second lens may have a concave shape on one surface. For example, the second lens may have a concave image-side surface. The second lens may include a spherical surface or aspherical surface. For example, both surfaces of the second lens may be aspherical. The second lens may be formed of a material having high light transmittance and excellent processability. For example, the second lens may be formed of a plastic material or glass. The second lens may be configured to have a greater refractive index than the first lens. For example, a refractive index of the second lens may be greater than 1.6. The second lens may have a predetermined Abbe number. For example, an Abbe number of the second lens may be 20 or more. As a specific example, the Abbe number of the second lens may be greater than 20 and less than 30.

The third lens may have refractive power. For example, the third lens may have positive refractive power. The third lens may have a convex shape on one surface. For example, the third lens may have a convex object-side surface. The third lens may include a spherical surface or aspherical surface. For example, both surfaces of the third lens may be aspherical. The third lens may be formed of a material having high light transmittance and excellent processability. For example, the third lens may be formed of a plastic material. The third lens may be configured to have a lower refractive index than the second lens. For example, a refractive index of the third lens may be less than 1.6. The third lens may have a predetermined Abbe number. For example, an Abbe number of the third lens may be greater than 50. As a specific example, the Abbe number of the third lens may be greater than 50 and less than 60.

The fourth lens may have refractive power. For example, the fourth lens may have negative refractive power. The fourth lens may have a concave shape on one surface. For example, the fourth lens may have a concave object-side surface. The fourth lens may include a spherical surface or aspherical surface. For example, both surfaces of the fourth lens may be aspherical. The fourth lens may be formed of a material having high light transmittance and excellent processability. For example, the fourth lens may be formed of a plastic material. The fourth lens may be configured to have a lower refractive index than the second lens. As an example, a refractive index of the fourth lens may be less than 1.6. The fourth lens may have a predetermined Abbe number. For example, an Abbe number of the fourth lens may be greater than 50. As a specific example, the Abbe number of the fourth lens may be greater than 50 and less than 60.

The fifth lens may have refractive power. For example, the fifth lens may have positive refractive power. The fifth lens may have a convex shape on one surface. For example, the fifth lens may have a convex image-side surface. The fifth lens may include a spherical surface or aspherical surface. For example, both surfaces of the fifth lens may be aspherical. The fifth lens may be formed of a material having high light transmittance and excellent processability. For example, the fifth lens may be formed of a plastic material. The fifth lens may be configured to have a greater refractive index than the fourth lens. As an example, a refractive index of the fifth lens may be greater than 1.6. The fifth lens may have a predetermined Abbe number. For example, an Abbe number of the fifth lens may be greater than 20. As a specific example, the Abbe number of the fifth lens may be greater than 20 and less than 30.

The sixth lens may have refractive power. For example, the sixth lens may have negative refractive power. The sixth lens may have a concave shape on one surface. As an example, the sixth lens may have a concave object-side surface. As another example, the sixth lens may have a concave image-side surface. The sixth lens may include a spherical surface or aspherical surface. For example, both surfaces of the sixth lens may be aspherical. The sixth lens may have inflection point. For example, an inflection point may be formed on the image-side surface of the sixth lens. The sixth lens may be formed of a material having high light transmittance and excellent processability. For example, the sixth lens may be formed of a plastic material. The sixth lens may be configured to have a predetermined refractive index. As an example, a refractive index of the sixth lens may be less than 1.6. The sixth lens may have a predetermined Abbe number. For example, an Abbe number of the sixth lens may be greater than 50. As a specific example, the Abbe number of the sixth lens may be greater than 50 and less than 60.

The seventh lens may have refractive power. For example, the seventh lens may have negative refractive power. The seventh lens may have a convex shape on one surface. As an example, the seventh lens may have a convex object-side surface. The seventh lens may include a spherical surface or aspherical surface. For example, both surfaces of the seventh lens may be aspherical. The seventh lens may have inflection point. For example, an inflection point may be formed on the image-side surface of the seventh lens. The seventh lens may be made of a material with high light transmittance and excellent processability. For example, the seventh lens may be formed of a plastic material. The seventh lens may be configured to have a predetermined refractive index. As an example, a refractive index of the seventh lens may be less than 1.6. The seventh lens may have a predetermined Abbe number. For example, an Abbe number of the seventh lens may be greater than 50. As a specific example, the Abbe number of the seventh lens may be greater than 50 and less than 60.

As described above, the first to seventh lenses may include a spherical surface or an aspherical surface. When the first to seventh lenses include an aspherical surface, the aspherical surface of the corresponding lens may be expressed by Equation 1 below.

$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20} \qquad Equation 1$$

In Equation 1, c is the reciprocal of a radius of curvature of a corresponding lens, k is a conic constant, r is a distance from any point on an aspherical surface to an optical axis, A to H and J are aspherical surface constants, and Z (or SAG) is a height in an optical axis direction from a certain point on the aspherical surface to a vertex of the corresponding aspherical surface.

An imaging lens system according to the above-described embodiment or the above-described form may further include a filter. The filter may be disposed between the rearmost lens (the sixth lens or the seventh lens) and the imaging plane. The filter may be configured to block light of specific wavelengths. For reference, the filter described in the one or more embodiments is configured to block infrared rays, but the wavelength of light blocked through the filter is not limited to infrared rays.

Hereinafter, specific embodiments will be described in detail based on the attached illustration drawings.

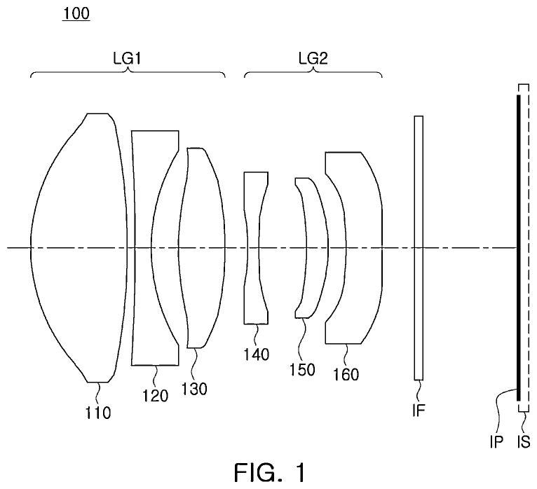

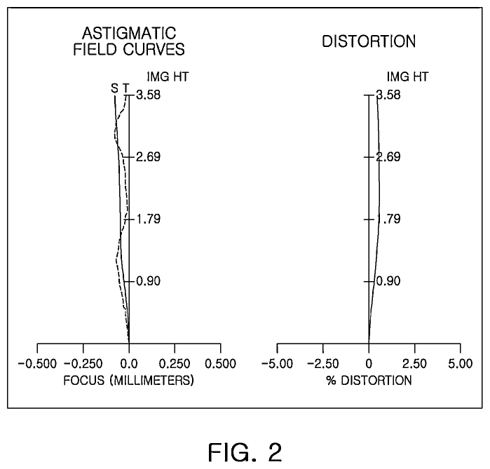

First, an example imaging lens system according to a first embodiment will be described with reference to FIGS. 1 and 2.

The example imaging lens system 100 may be comprised of a plurality of lens groups. In an example, the example imaging lens system 100 may include a first lens group (LG1) and a second lens group (LG2). The first lens group LG1 and the second lens group LG2 may be arranged sequentially from an object side toward an imaging plane. The first lens group (LG1) and the second lens group (LG2) may include one or more lenses. In a non-limited example, the first lens group (LG1) and the second lens group (LG2) may each be comprised of three lenses.

The first lens group LG1 may be comprised of a first lens 110, a second lens 120, and a third lens 130. The first lens 110 may have positive refractive power, and may have a convex object-side surface and a convex image-side surface. The second lens 120 may have negative refractive power, and may have a concave object-side surface and a concave image-side surface. The third lens 130 may have positive refractive power, and may have a convex object-side surface and a convex image-side surface.

The second lens group LG2 may be comprised of a fourth lens 140, a fifth lens 150, and a sixth lens 160. The fourth lens 140 may have negative refractive power, and may have a concave object-side surface and a convex image-side surface. The fifth lens 150 may have positive refractive power and may have a concave object-side surface and a convex image-side surface. The sixth lens 160 may have negative refractive power and may have a concave object-side surface and a concave image-side surface.

In an example, the second lens group LG2 may be configured to be movable in the optical axis direction. Therefore, the example imaging lens system 100 according to the first embodiment may enable auto focus adjustment (AF) and focus magnification adjustment (Zoom) of the camera module through movement of the second lens group LG2.

The example imaging lens system 100 may further include other lens elements in addition to the first lens 110 to the sixth lens 160. For example, the imaging lens system 100 may further include a filter (IF) and an imaging plane (IP). The filter (IF) may be disposed between the sixth lens 160 and the imaging plane (IP). The imaging plane (IP) may be formed in a location in which light incident from the first lens 110 to the sixth lens 160 forms an image. In an example, the imaging plane (IP) may be formed on one surface of an image sensor (IS) of a camera module or on a lens element disposed inside the image sensor (IS).

The example imaging lens system 100 according to the first embodiment may capture images of close objects and distant objects. As an example, the imaging lens system 100 may generally capture an object located at a long distance. As another example, the example imaging lens system 100 may change the position of the second lens group LG2 to capture an image of an object located at a relatively short distance (e.g., 100 mm).

FIG. 2 illustrates aberration characteristics of an example imaging lens system 100 according to the first embodiment. Tables 1 and 2 below illustrate lens characteristics and aspherical values of the imaging lens system according to the first embodiment.

TABLE 1

| Surface | | Curvature | Thickness/ | Refractive | | |
|---|---|---|---|---|---|---|
| No. | Component | Radius | Distance | Index | Abbe No. | Effective Radius |
| S1 | 1st Lens | 4.0768 | 2.415 | 1.537 | 55.7 | 3.25 |
| S2 | | −12.1804 | 0.173 | | | 3.08 |
| S3 | 2nd Lens | −101.9269 | 0.403 | 1.619 | 25.9 | 2.82 |
| S4 | | 4.8345 | 0.705 | | | 2.46 |
| S5 | 3rd Lens | 8.2627 | 1.157 | 1.537 | 55.7 | 2.42 |
| S6 | | −7.8237 | 0.550 | | | 2.41 |
| S7 | | Infinity | AF | | | 2.00 |
| S8 | 4th Lens | −3.6421 | 0.285 | 1.546 | 56.0 | 1.84 |
| S9 | | −16.0000 | 1.221 | | | 1.67 |
| S10 | 5th Lens | −4.8305 | 0.500 | 1.667 | 20.4 | 1.57 |
| S11 | | −3.8962 | 0.450 | | | 1.70 |
| S12 | 6th Lens | −7.5968 | 0.900 | 1.546 | 56.0 | 1.84 |
| S13 | | 161.5361 | 0.800 | | | 2.32 |
| S14 | | Infinity | −AF | | | 3.01 |
| S15 | | Infinity | 0.000 | | | 2.90 |
| S16 | Filter | Infinity | 0.210 | 1.518 | 64.2 | 2.90 |
| S17 | | Infinity | 2.352 | | | 2.96 |
| S18 | Imaging | | 0.000 | | | |
| | plane | | | | | |

TABLE 2

| Surface | | | | | | |
|---|---|---|---|---|---|---|
| No. | S1 | S2 | S3 | S4 | S5 | S6 |
| K | −4.064E−01 | −1.832E+00 | −3.401E+01 | 1.260E+00 | 9.176E−03 | 3.862E−03 |
| A | 5.271E−04 | 8.146E−03 | 2.230E−02 | 2.386E−02 | −4.679E−03 | −1.270E−02 |
| B | −6.053E−04 | −1.979E−02 | −5.137E−02 | −3.689E−02 | −8.724E−04 | 2.431E−02 |
| C | 3.666E−04 | 2.371E−02 | 6.362E−02 | 3.997E−02 | 3.677E−03 | −3.197E−02 |
| D | −1.346E−04 | −1.702E−02 | −5.144E−02 | −2.878E−02 | −3.691E−03 | 2.872E−02 |
| E | 3.048E−05 | 8.262E−03 | 2.915E−02 | 1.255E−02 | 2.167E−03 | −1.805E−02 |
| F | −4.298E−06 | −2.845E−03 | −1.192E−02 | −2.201E−03 | −7.862E−04 | 8.113E−03 |
| G | 3.672E−07 | 7.114E−04 | 3.581E−03 | −8.537E−04 | 1.552E−04 | −2.636E−03 |
| H | −1.742E−08 | −1.306E−04 | −7.960E−04 | 7.197E−04 | −2.824E−06 | 6.200E−04 |
| J | 3.497E−10 | 1.761E−05 | 1.308E−04 | −2.468E−04 | −7.002E−06 | −1.044E−04 |
| L | 0.000E+00 | −1.724E−06 | −1.572E−05 | 5.132E−05 | 1.923E−06 | 1.227E−05 |
| M | 0.000E+00 | 1.193E−07 | 1.342E−06 | −6.878E−06 | −2.532E−07 | −9.526E−07 |
| N | 0.000E+00 | −5.535E−09 | −7.719E−08 | 5.824E−07 | 1.740E−08 | 4.385E−08 |
| O | 0.000E+00 | 1.544E−10 | 2.681E−09 | −2.838E−08 | −5.021E−10 | −9.032E−10 |
| P | 0.000E+00 | −1.958E−12 | −4.249E−11 | 6.052E−10 | 0.000E+00 | 0.000E+00 |

| Surface | | | | | | |
|---|---|---|---|---|---|---|
| No. | S8 | S9 | S10 | S11 | S12 | S13 |
| K | −4.512E+01 | −9.000E+01 | 6.775E+00 | −1.767E+01 | −1.364E+01 | −9.000E+01 |
| A | 2.529E−03 | 1.192E−01 | 2.755E−02 | −1.418E−02 | −2.111E−02 | −2.399E−02 |
| B | 9.303E−02 | −1.266E−01 | 1.130E−02 | −2.671E−02 | −4.405E−02 | 1.237E−03 |
| C | −1.983E−01 | 4.188E−01 | −8.252E−02 | 2.042E−01 | 1.864E−01 | −5.953E−03 |
| D | 3.137E−01 | −1.274E+00 | 2.123E−01 | −6.933E−01 | −4.669E−01 | 2.230E−02 |
| E | −4.231E−01 | 2.633E+00 | −3.650E−01 | 1.426E+00 | 7.658E−01 | −3.501E−02 |
| F | 4.692E−01 | −3.770E+00 | 4.402E−01 | −1.962E+00 | −8.748E−01 | 3.217E−02 |
| G | −4.044E−01 | 3.842E+00 | −3.796E−01 | 1.887E+00 | 7.191E−01 | −1.937E−02 |
| H | 2.611E−01 | −2.829E+00 | 2.344E−01 | −1.297E+00 | −4.317E−01 | 8.024E−03 |
| J | −1.235E−01 | 1.509E+00 | −1.021E−01 | 6.413E−01 | 1.894E−01 | −2.333E−03 |
| L | 4.192E−02 | −5.778E−01 | 3.005E−02 | −2.266E−01 | −6.002E−02 | 4.757E−04 |
| M | −9.906E−03 | 1.547E−01 | −5.471E−03 | 5.585E−02 | 1.336E−02 | −6.670E−05 |
| N | 1.545E−03 | −2.748E−02 | 4.790E−04 | −9.127E−03 | −1.981E−03 | 6.125E−06 |
| O | −1.428E−04 | 2.910E−03 | 4.593E−06 | 8.889E−04 | 1.755E−04 | −3.317E−07 |
| P | 5.919E−06 | −1.389E−04 | −2.893E−06 | −3.906E−05 | −7.016E−06 | 8.029E−09 |

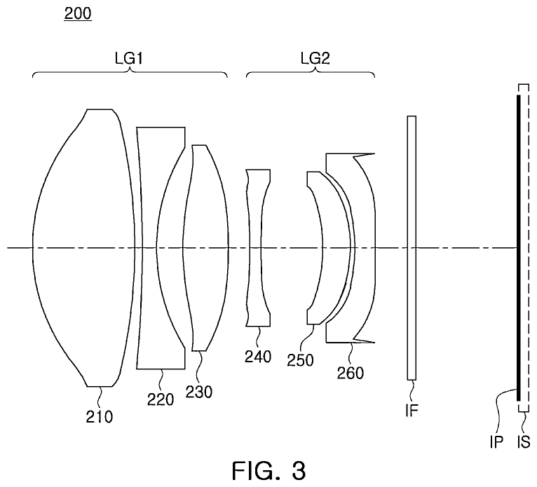

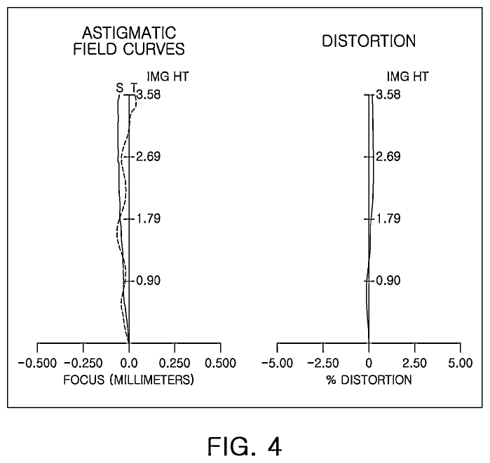

An example imaging lens system according to a second embodiment will be described with reference to FIGS. 3 and 4.

The example imaging lens system 200 may include a plurality of lens groups. For example, the example imaging lens system 200 may include a first lens group (LG1) and a second lens group (LG2). The first lens group LG1 and the second lens group LG2 may be arranged sequentially from an object side toward an imaging plane. The first lens group (LG1) and the second lens group (LG2) may include one or more lenses. For example, the first lens group (LG1) and the second lens group (LG2) may each be comprised of three lenses.

The first lens group LG1 may include a first lens 210, a second lens 220, and a third lens 230. The first lens 210 may have positive refractive power, and may have a convex object-side surface and a convex image-side surface. The second lens 220 may have negative refractive power and may have a concave object-side surface and a concave image-side surface. The third lens 230 may have positive refractive power and may have a convex object-side surface and a convex image-side surface.

The second lens group LG2 may include a fourth lens 240, a fifth lens 250, and a sixth lens 260. The fourth lens 240 may have negative refractive power and may have a concave object-side surface and a convex image-side surface. The fifth lens 250 may have positive refractive power and may have a concave object-side surface and a convex image-side surface. The sixth lens 260 may have negative refractive power and may have a concave object-side surface and a concave image-side surface.

The second lens group LG2 may be configured to be movable in an optical axis direction. Therefore, the imaging lens system 200 according to the second embodiment may enable auto focus adjustment (AF) and focus magnification adjustment (Zoom) of a camera module through movement of the second lens group LG2.

The example imaging lens system 200 may further include other lens elements in addition to the first lens 210 to the sixth lens 260. For example, the example imaging lens system 200 may further include a filter (IF) and an imaging plane (IP). The filter (IF) may be disposed between the sixth lens 260 and the imaging plane (IP). The imaging plane (IP) may be formed in a position in which light incident from the first lens 210 to the sixth lens 260 forms an image. For example, the imaging plane (IP) may be formed on one surface of an image sensor (IS) of the camera module or on a lens element disposed inside the image sensor (IS).

The example imaging lens system 200 according to the second embodiment may capture images of close and distant objects. For example, the example imaging lens system 200 may generally capture images of objects located at a long distance. As another example, the example imaging lens system 200 may change the position of the second lens group LG2 to capture an object located at a relatively close distance (e.g., 100 mm).

FIG. 4 illustrates aberration characteristics of the example imaging lens system 200 according to the second embodiment. Tables 3 and 4 below illustrate characteristics and aspherical values of the imaging lens system according to the present embodiment.

TABLE 3

| Surface | | Curvature | Thickness/ | Refractive | Abbe | Effective |
|---|---|---|---|---|---|---|
| No. | Component | Radius | Distance | Index | No. | Radius |
| S1 | 1st Lens | 4.1581 | 2.582 | 1.537 | 55.7 | 3.31 |
| S2 | | −9.9357 | 0.173 | | | 3.18 |
| S3 | 2nd Lens | −22.2960 | 0.342 | 1.619 | 25.9 | 2.91 |
| S4 | | 5.2450 | 0.661 | | | 2.56 |
| S5 | 3rd Lens | 7.2919 | 1.145 | 1.537 | 55.7 | 2.53 |
| S6 | | −8.2125 | 0.550 | | | 2.54 |
| S7 | | Infinity | 0.000 | | | 2.03 |
| S8 | 4th Lens | −3.3096 | 0.260 | 1.546 | 56.0 | 1.91 |
| S9 | | −11.2445 | 1.498 | | | 1.74 |
| S10 | 5th Lens | −4.9850 | 0.710 | 1.619 | 25.9 | 1.59 |
| S11 | | −3.3186 | 0.101 | | | 1.84 |
| S12 | 6th Lens | −9.2572 | 0.522 | 1.546 | 56.0 | 1.88 |
| S13 | | 11.4985 | 0.800 | | | 2.26 |
| S14 | | Infinity | 0.000 | | | 2.93 |
| S15 | | Infinity | 0.000 | | | 2.84 |
| S16 | Filter | Infinity | 0.210 | 1.518 | 64.2 | 2.84 |
| S17 | | Infinity | 2.564 | | | 2.90 |
| S18 | Imaging | | 0.000 | | | |
| | plane | | | | | |

TABLE 4

| Surface | | | | | | |
|---|---|---|---|---|---|---|
| No. | S1 | S2 | S3 | S4 | S5 | S6 |
| K | −4.501E−01 | −1.971E+00 | −1.630E+01 | 1.263E+00 | −6.997E+00 | 5.652E+00 |
| A | −2.733E−05 | 5.287E−03 | 1.071E−02 | 1.179E−02 | 4.497E−03 | 4.261E−03 |
| B | 5.497E−04 | −1.116E−02 | −2.913E−02 | −2.095E−02 | 4.502E−03 | −1.381E−02 |
| C | −8.245E−04 | 1.287E−02 | 3.422E−02 | 1.869E−02 | −1.617E−02 | 2.322E−02 |
| D | 6.989E−04 | −8.224E−03 | −2.311E−02 | −6.677E−03 | 1.939E−02 | −2.711E−02 |
| E | −3.850E−04 | 3.463E−03 | 1.035E−02 | −2.458E−03 | −1.345E−02 | 2.192E−02 |
| F | 1.446E−04 | −1.035E−03 | −3.287E−03 | 4.283E−03 | 5.648E−03 | −1.254E−02 |
| G | −3.810E−05 | 2.271E−04 | 7.640E−04 | −2.619E−03 | −1.291E−03 | 5.184E−03 |
| H | 7.165E−06 | −3.708E−05 | −1.318E−04 | 1.004E−03 | 3.575E−05 | −1.571E−03 |
| J | −9.656E−07 | 4.504E−06 | 1.687E−05 | −2.668E−04 | 7.544E−05 | 3.496E−04 |
| L | 9.256E−08 | −4.018E−07 | −1.584E−06 | 5.015E−05 | −2.570E−05 | −5.660E−05 |
| M | −6.160E−09 | 2.557E−08 | 1.061E−07 | −6.565E−06 | 4.414E−06 | 6.491E−06 |
| N | 2.705E−10 | −1.099E−09 | −4.787E−09 | 5.696E−07 | −4.415E−07 | −5.000E−07 |
| O | −7.051E−12 | 2.857E−11 | 1.303E−10 | −2.940E−08 | 2.447E−08 | 2.320E−08 |
| P | 8.260E−14 | −3.392E−13 | −1.607E−12 | 6.826E−10 | −5.833E−10 | −4.900E−10 |

| Surface | | | | | | |
|---|---|---|---|---|---|---|
| No. | S8 | S9 | S10 | S11 | S12 | S13 |
| K | −3.824E+01 | −7.613E+01 | 7.764E+00 | −1.070E+01 | 2.191E+01 | 2.419E+01 |
| A | −6.031E−03 | 1.041E−01 | 3.666E−02 | −5.231E−02 | −7.701E−02 | −6.393E−02 |
| B | 1.148E−01 | −2.414E−02 | −1.958E−01 | 9.269E−03 | −1.438E−01 | −4.467E−02 |
| C | −2.258E−01 | −7.029E−02 | 1.044E+00 | 2.722E−01 | 9.745E−01 | 2.300E−01 |
| D | 2.949E−01 | 1.671E−01 | −3.525E+00 | −1.059E+00 | −2.748E+00 | −4.573E−01 |
| E | −2.940E−01 | −2.427E−01 | 7.895E+00 | 2.175E+00 | 4.785E+00 | 5.689E−01 |
| F | 2.361E−01 | 2.840E−01 | −1.231E+01 | −2.897E+00 | −5.646E+00 | −4.838E−01 |
| G | −1.560E−01 | −2.794E−01 | 1.376E+01 | 2.670E+00 | 4.698E+00 | 2.916E−01 |
| H | 8.381E−02 | 2.187E−01 | −1.118E+01 | −1.752E+00 | −2.808E+00 | −1.266E−01 |
| J | −3.532E−02 | −1.280E−01 | 6.617E+00 | 8.257E−01 | 1.211E+00 | 3.973E−02 |
| L | 1.117E−02 | 5.359E−02 | −2.826E+00 | −2.777E−01 | −3.736E−01 | −8.920E−03 |
| M | −2.518E−03 | −1.543E−02 | 8.476E−01 | 6.516E−02 | 8.039E−02 | 1.397E−03 |
| N | 3.789E−04 | 2.888E−03 | −1.694E−01 | −1.014E−02 | −1.146E−02 | −1.447E−04 |
| O | −3.392E−05 | −3.162E−04 | 2.026E−02 | 9.410E−04 | 9.733E−04 | 8.917E−06 |
| P | 1.362E−06 | 1.534E−05 | −1.096E−03 | −3.945E−05 | −3.728E−05 | −2.472E−07 |

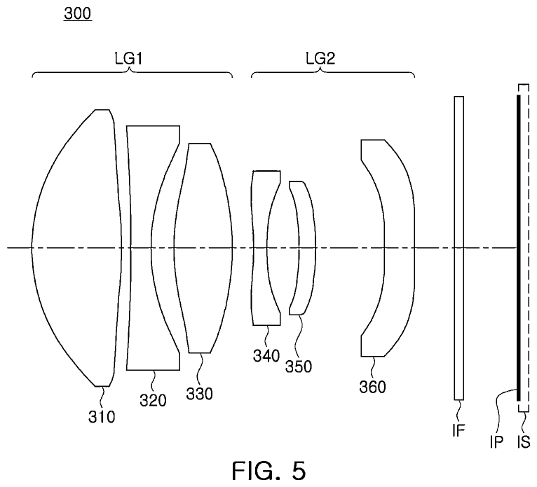

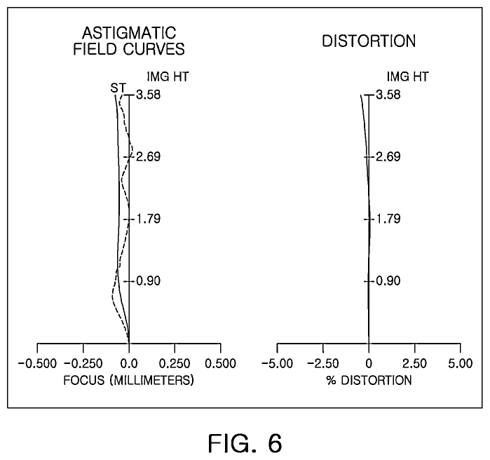

An example imaging lens system according to a third embodiment will be described with reference to FIGS. 5 and 6.

The example imaging lens system 300 may include a plurality of lens groups. For example, the example imaging lens system 300 may include a first lens group (LG1) and a second lens group (LG2). The first lens group LG1 and the second lens group LG2 may be arranged sequentially from an object side toward an imaging plane. The first lens group (LG1) and the second lens group (LG2) may include one or more lenses. For example, the first lens group (LG1) and the second lens group (LG2) may each be comprised of three lenses.

The first lens group LG1 may include a first lens 310, a second lens 320, and a third lens 330. The first lens 310 may have positive refractive power and may have a convex object-side surface and a convex image-side surface. The second lens 320 may have negative refractive power and may have a concave object-side surface and a concave image-side surface. The third lens 330 may have positive refractive power and may have a convex object-side surface and a convex image-side surface.

The second lens group LG2 may include a fourth lens 340, a fifth lens 350, and a sixth lens 360. The fourth lens 340 may have negative refractive power and may have a concave object-side surface and a concave image-side surface. The fifth lens 350 may have positive refractive power and may have a concave object-side surface and a convex image-side surface. The sixth lens 360 may have negative refractive power and may have a concave object-side surface and a concave image-side surface.

The second lens group LG2 may be configured to be movable in an optical axis direction. Therefore, the example imaging lens system 300 according to the third embodiment may enable auto focus adjustment (AF) and focus magnification adjustment (Zoom) of a camera module through movement of the second lens group LG2.

The example imaging lens system 300 may further include other lens elements in addition to the first to sixth lenses 310 to 360. For example, the example imaging lens system 300 may further include a filter (IF) and an imaging plane (IP). The filter (IF) may be disposed between the sixth lens 360 and the imaging plane (IP). The imaging plane (IP) may be formed in a location in which light incident from the first lens 310 to the sixth lens 360 forms an image. For example, the upper surface IP may be formed on one surface of an image sensor (IS) of the camera module or on a lens element disposed inside the image sensor (IS).

The example imaging lens system 300 according to the third embodiment may capture images of close and distant objects. As an example, the imaging lens system 300 may generally capture an object located at a long distance. As another example, the imaging lens system 300 may change a position of the second lens group LG2 to capture an object located at a relatively close distance (e.g., 100 mm).

FIG. 6 illustrates aberration characteristics of the example imaging lens system 300 according to the third embodiment. Tables 5 and 6 below illustrate the lens characteristics and aspherical values of the example imaging lens system according to the third embodiment.

TABLE 5

| Surface | | Curvature | Thickness/ | Refractive | Abbe | Effective |
|---|---|---|---|---|---|---|
| No. | Component | Radius | Distance | Index | No. | Radius |
| S1 | 1st Lens | 4.2128 | 2.240 | 1.537 | 55.7 | 3.32 |
| S2 | | −13.3365 | 0.234 | | | 3.16 |
| S3 | 2nd Lens | −30.9871 | 0.500 | 1.619 | 25.9 | 2.94 |
| S4 | | 5.2515 | 0.567 | | | 2.58 |
| S5 | 3rd Lens | 6.6395 | 1.429 | 1.537 | 55.7 | 2.54 |
| S6 | | −7.9019 | 0.550 | | | 2.47 |
| S7 | | Infinity | AF | | | 2.03 |
| S8 | 4th Lens | −4.9659 | 0.324 | 1.546 | 56.0 | 1.86 |
| S9 | | 15.6761 | 0.794 | | | 1.61 |
| S10 | 5th Lens | −13.3241 | 0.440 | 1.644 | 23.5 | 1.52 |
| S11 | | −8.6038 | 1.709 | | | 1.61 |
| S12 | 6th Lens | −20.3030 | 0.735 | 1.546 | 56.0 | 2.22 |
| S13 | | 25.3242 | 1.012 | | | 2.61 |
| S14 | | Infinity | −AF | | | 3.54 |
| S15 | | Infinity | 0.000 | | | 3.34 |
| S16 | Filter | Infinity | 0.210 | 1.518 | 64.2 | 3.34 |
| S17 | | Infinity | 1.378 | | | 3.40 |
| S18 | Imaging | | −0.002 | | | |
| | Plane | | | | | |

TABLE 6

| Surface | | | | | | |
|---|---|---|---|---|---|---|
| No. | S1 | S2 | S3 | S4 | S5 | S6 |
| K | −2.744E−01 | 3.018E−01 | −9.000E+01 | 1.973E+00 | −5.219E−01 | −1.943E+00 |
| A | −3.446E−04 | −1.053E−02 | −2.140E−02 | −9.950E−03 | −1.280E−03 | −3.737E−04 |
| B | 2.818E−04 | 1.162E−02 | 1.945E−02 | 3.455E−03 | 2.630E−03 | −5.249E−04 |
| C | −1.859E−04 | −4.896E−03 | −2.977E−03 | 1.537E−02 | −1.458E−03 | −2.001E−04 |
| D | 7.723E−05 | 1.235E−03 | −5.241E−03 | −2.311E−02 | −1.564E−05 | 2.717E−04 |
| E | −1.898E−05 | −2.003E−04 | 4.638E−03 | 1.690E−02 | 2.453E−04 | −1.178E−04 |
| F | 2.831E−06 | 2.114E−05 | −2.090E−03 | −7.902E−03 | −9.216E−05 | 2.720E−05 |
| G | −2.538E−07 | −1.409E−06 | 6.234E−04 | 2.549E−03 | 1.583E−05 | −3.620E−06 |
| H | 1.267E−08 | 5.384E−08 | −1.320E−04 | −5.772E−04 | −1.367E−06 | 2.615E−07 |
| J | −2.727E−10 | −8.997E−10 | 2.024E−05 | 9.023E−05 | 4.859E−08 | −7.801E−09 |
| L | 0.000E+00 | 0.000E+00 | −2.239E−06 | −9.184E−06 | 0.000E+00 | 0.000E+00 |
| M | 0.000E+00 | 0.000E+00 | 1.744E−07 | 5.136E−07 | 0.000E+00 | 0.000E+00 |
| N | 0.000E+00 | 0.000E+00 | −9.074E−09 | −4.022E−09 | 0.000E+00 | 0.000E+00 |
| O | 0.000E+00 | 0.000E+00 | 2.834E−10 | −1.199E−09 | 0.000E+00 | 0.000E+00 |
| P | 0.000E+00 | 0.000E+00 | −4.016E−12 | 4.948E−11 | 0.000E+00 | 0.000E+00 |

| Surface | | | | | | |
|---|---|---|---|---|---|---|
| No. | S8 | S9 | S10 | S11 | S12 | S13 |
| K | −8.889E+01 | 8.888E+01 | −9.000E+01 | −9.000E+01 | 7.993E+01 | −8.481E+01 |
| A | −1.422E−02 | 7.132E−02 | 1.049E−03 | −4.625E−02 | −3.691E−02 | −2.652E−02 |
| B | 1.500E−01 | 3.939E−02 | −1.835E−01 | 8.111E−02 | 1.789E−02 | −5.401E−03 |
| C | −4.221E−01 | −3.281E−01 | 8.534E−01 | −4.300E−01 | −3.443E−02 | 1.513E−02 |
| D | 8.778E−01 | 1.029E+00 | −2.746E+00 | 1.540E+00 | 6.826E−02 | −1.472E−02 |
| E | −1.354E+00 | −2.152E+00 | 6.284E+00 | −3.627E+00 | −9.866E−02 | 7.886E−03 |
| F | 1.524E+00 | 3.156E+00 | −1.037E+01 | 5.841E+00 | 1.004E−01 | −1.740E−03 |
| G | −1.249E+00 | −3.295E+00 | 1.245E+01 | −6.619E+00 | −7.210E−02 | −5.811E−04 |
| H | 7.459E−01 | 2.460E+00 | −1.092E+01 | 5.363E+00 | 3.670E−02 | 6.004E−04 |
| J | −3.235E−01 | −1.309E+00 | 6.976E+00 | −3.120E+00 | −1.325E−02 | −2.298E−04 |
| L | 1.007E−01 | 4.892E−01 | −3.203E+00 | 1.293E+00 | 3.367E−03 | 5.217E−05 |
| M | −2.189E−02 | −1.242E−01 | 1.029E+00 | −3.720E−01 | −5.876E−04 | −7.544E−06 |
| N | 3.156E−03 | 2.014E−02 | −2.192E−01 | 7.066E−02 | 6.704E−05 | 6.844E−07 |
| O | −2.709E−04 | −1.841E−03 | 2.783E−02 | −7.963E−03 | −4.500E−06 | −3.565E−08 |
| P | 1.048E−05 | 6.916E−05 | −1.592E−03 | 4.031E−04 | 1.348E−07 | 8.149E−10 |

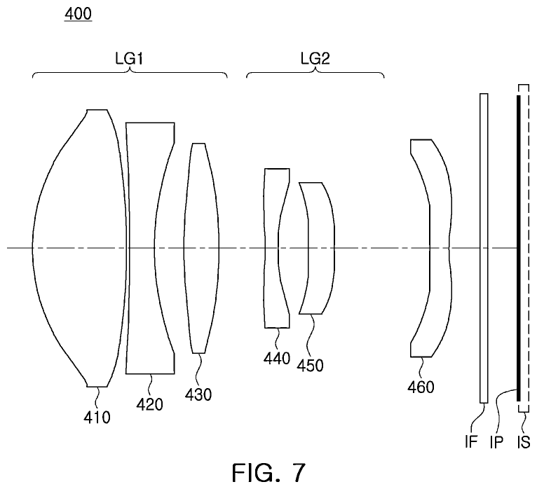

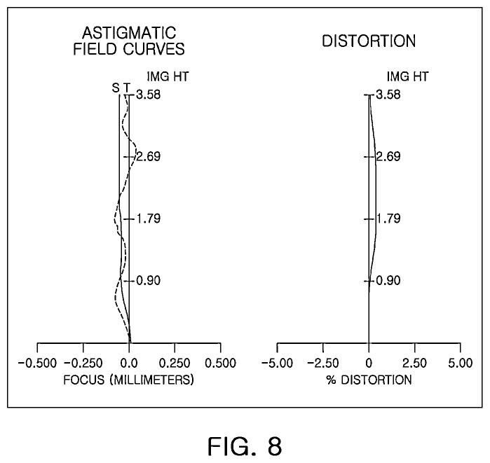

An example imaging lens system according to a fourth embodiment will be described with reference to FIGS. 7 and 8.

An example imaging lens system 400 may include a plurality of lens groups. For example, the example imaging lens system 400 may include a first lens group (LG1) and a second lens group (LG2). The first lens group LG1 and the second lens group LG2 may be arranged sequentially from an object side toward an imaging plane. The first lens group (LG1) and the second lens group (LG2) may include one or more lenses. In a non-limited example, the first lens group (LG1) and the second lens group (LG2) may each be comprised of three lenses.

The first lens group LG1 may include a first lens 410, a second lens 420, and a third lens 430. The first lens 410 may have positive refractive power and may have a convex object-side surface and a convex image-side surface. The second lens 420 may have negative refractive power and may have a concave object-side surface and a concave image-side surface. The third lens 430 may have positive refractive power and may have a convex object-side surface and a convex image-side surface.

The second lens group LG2 may include a fourth lens 440, a fifth lens 450, and a sixth lens 460. The fourth lens 440 may have negative refractive power and may have a concave object-side surface and a concave image-side surface. The fifth lens 450 may have positive refractive power and may have a concave object-side surface and a convex image-side surface. The sixth lens 460 may have negative refractive power and may have a convex object-side surface and a concave image-side surface.

The second lens group LG2 may be configured to be movable in an optical axis direction. Therefore, the example imaging lens system 400 according to the fourth embodiment may enable auto focus adjustment (AF) and focus magnification adjustment (Zoom) of a camera module through movement of the second lens group LG2.

The example imaging lens system 400 may further include other lens elements in addition to the first lens 410 to the sixth lens 460. For example, the example imaging lens system 400 may further include a filter (IF) and an imaging plane (IP). The filter (IF) may be disposed between the sixth lens 460 and the imaging plane (IP). The imaging plane (IP) may be formed in a location in which light incident from the first lens 410 to the sixth lens 460 forms an image. For example, the imaging plane (IP) may be formed on one surface of an image sensor (IS) of the camera module or on a lens element disposed inside the image sensor (IS).

The example imaging lens system 400 according to the fourth embodiment may capture images of close and distant objects. As an example, the imaging lens system 400 may generally image an object located at a long distance. As another example, the imaging lens system 400 may change a position of the second lens group LG2 to capture an object located at a relatively close distance (e.g., 100 mm).

FIG. 8 illustrates aberration characteristics of the example imaging lens system 400 according to the fourth embodiment. Tables 7 and 8 illustrate lens characteristics and aspherical values of the example imaging lens system according to the fourth embodiment.

TABLE 7

| Surface | | Curvature | Thickness or | Refractive | Abbe | Effective |
|---|---|---|---|---|---|---|
| No. | Component | Radius | Distance | Index | No. | Radius |
| S1 | 1st Lens | 4.2823 | 2.353 | 1.537 | 55.7 | 3.32 |
| S2 | | −12.0672 | 0.100 | | | 3.22 |
| S3 | 2nd Lens | −32.2914 | 0.607 | 1.619 | 25.9 | 3.02 |
| S4 | | 7.3519 | 0.709 | | | 2.64 |
| S5 | 3rd Lens | 9.9337 | 0.900 | 1.537 | 55.7 | 2.54 |
| S6 | | −9.8909 | 0.550 | | | 2.45 |
| S7 | | Infinity | AF | | | 2.05 |
| S8 | 4th Lens | −4.0214 | 0.309 | 1.570 | 37.4 | 1.93 |
| S9 | | 48.2307 | 0.757 | | | 1.69 |
| S10 | 5th Lens | −14.2932 | 0.631 | 1.677 | 19.2 | 1.57 |
| S11 | | −7.9058 | 2.384 | | | 1.60 |
| S12 | 6th Lens | 21.7620 | 0.489 | 1.546 | 56.0 | 2.38 |
| S13 | | 6.8488 | 1.346 | | | 2.67 |
| S14 | | Infinity | −AF | | | 3.64 |
| S15 | | Infinity | 0.000 | | | 3.41 |
| S16 | Filter | Infinity | 0.210 | 1.518 | 64.2 | 3.41 |
| S17 | | Infinity | 0.784 | | | 3.47 |
| S18 | Imaging | | −0.011 | | | |
| | Plane | | | | | |

TABLE 8

| Surface | | | | | | |
|---|---|---|---|---|---|---|
| No. | S1 | S2 | S3 | S4 | S5 | S6 |
| K | −2.949E−01 | 1.445E+00 | 6.118E+01 | 2.055E+00 | −7.511E+00 | 4.685E−01 |
| A | −1.645E−04 | −1.103E−02 | −1.538E−02 | −4.621E−03 | −3.190E−03 | 2.904E−03 |
| B | 7.924E−04 | 3.407E−02 | 4.144E−02 | 1.114E−02 | 8.843E−03 | −1.982E−02 |
| C | −9.950E−04 | −3.649E−02 | −4.786E−02 | −1.458E−02 | −2.052E−02 | 3.630E−02 |
| D | 7.627E−04 | 2.284E−02 | 3.221E−02 | 9.201E−03 | 2.316E−02 | −4.473E−02 |
| E | −3.817E−04 | −9.496E−03 | −1.431E−02 | −2.386E−03 | −1.599E−02 | 3.909E−02 |
| F | 1.301E−04 | 2.796E−03 | 4.503E−03 | −4.460E−04 | 7.483E−03 | −2.441E−02 |
| G | −3.123E−05 | −6.022E−04 | −1.043E−03 | 6.163E−04 | −2.455E−03 | 1.100E−02 |
| H | 5.377E−06 | 9.618E−05 | 1.806E−04 | −2.605E−04 | 5.615E−04 | −3.610E−03 |
| J | −6.680E−07 | −1.139E−05 | −2.342E−05 | 6.696E−05 | −8.582E−05 | 8.632E−04 |
| L | 5.944E−08 | 9.872E−07 | 2.244E−06 | −1.154E−05 | 7.780E−06 | −1.489E−04 |
| M | −3.696E−09 | −6.081E−08 | −1.542E−07 | 1.347E−06 | −2.278E−07 | 1.807E−05 |
| N | 1.526E−10 | 2.519E−09 | 7.192E−09 | −1.026E−07 | −2.973E−08 | −1.463E−06 |
| O | −3.761E−12 | −6.291E−11 | −2.036E−10 | 4.615E−09 | 3.352E−09 | 7.097E−08 |
| P | 4.188E−14 | 7.146E−13 | 2.639E−12 | −9.330E−11 | −1.073E−10 | −1.561E−09 |

| Surface | | | | | | |
|---|---|---|---|---|---|---|
| No. | S8 | S9 | S10 | S11 | S12 | S13 |
| K | −6.926E+01 | 5.641E+01 | −9.000E+01 | −3.465E+01 | 4.262E+01 | 4.109E+00 |
| A | −2.948E−02 | 9.160E−02 | −3.488E−03 | −3.509E−02 | −4.615E−02 | −4.278E−02 |
| B | 1.890E−01 | 5.204E−02 | −1.380E−01 | 1.097E−01 | 2.274E−02 | 3.858E−03 |
| C | −4.277E−01 | −4.724E−01 | 6.900E−01 | −5.450E−01 | −2.821E−02 | 7.826E−03 |
| D | 6.595E−01 | 1.444E+00 | −2.076E+00 | 1.677E+00 | 2.902E−02 | −1.066E−02 |
| E | −7.286E−01 | −2.851E+00 | 3.972E+00 | −3.424E+00 | −1.820E−02 | 7.427E−03 |
| F | 5.834E−01 | 3.928E+00 | −5.015E+00 | 4.862E+00 | 5.161E−03 | −3.187E−03 |
| G | −3.398E−01 | −3.880E+00 | 4.202E+00 | −4.934E+00 | 1.184E−03 | 8.301E−04 |
| H | 1.435E−01 | 2.779E+00 | −2.247E+00 | 3.630E+00 | −1.744E−03 | −1.019E−04 |
| J | −4.330E−02 | −1.443E+00 | 6.418E−01 | −1.941E+00 | 7.804E−04 | −8.939E−06 |
| L | 9.050E−03 | 5.372E−01 | 1.262E−02 | 7.477E−01 | −2.023E−04 | 6.032E−06 |
| M | −1.231E−03 | −1.397E−01 | −8.634E−02 | −2.022E−01 | 3.313E−05 | −1.134E−06 |
| N | 9.494E−05 | 2.406E−02 | 3.291E−02 | 3.645E−02 | −3.389E−06 | 1.139E−07 |
| O | −2.603E−06 | −2.468E−03 | −5.694E−03 | −3.937E−03 | 1.985E−07 | −6.169E−09 |
| P | −6.779E−08 | 1.141E−04 | 3.970E−04 | 1.928E−04 | −5.097E−09 | 1.419E−10 |

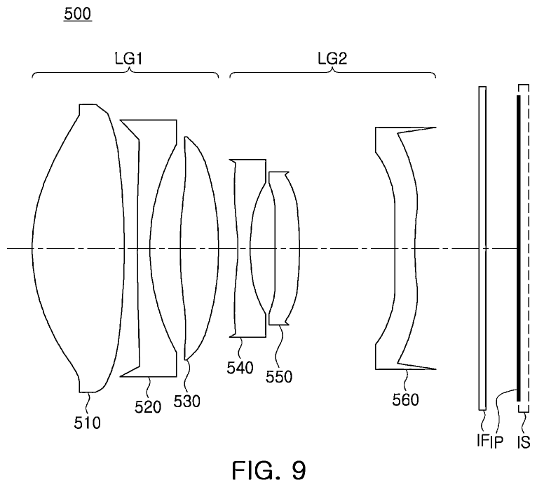

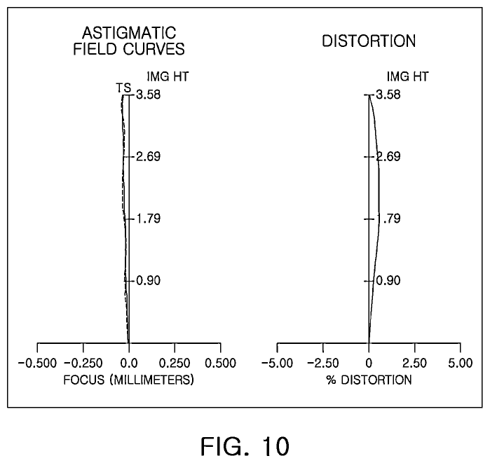

An example imaging lens system according to a fifth embodiment will be described with reference to FIGS. 9 and 10.

An example imaging lens system 500 may include a plurality of lens groups. For example, the imaging lens system 500 may include a first lens group (LG1) and a second lens group (LG2). The first lens group LG1 and the second lens group LG2 may be arranged sequentially from an object side toward an imaging plane. The first lens group (LG1) and the second lens group (LG2) may include one or more lenses. In an example, the first lens group (LG1) and the second lens group (LG2) may each be comprised of three lenses.

The first lens group LG1 may include a first lens 510, a second lens 520, and a third lens 530. The first lens 510 may have positive refractive power and may have a convex object-side surface and a convex image-side surface. The second lens 520 may have a negative refractive power and may have a convex object-side surface and a concave image-side surface. The third lens 530 may have positive refractive power and may have a convex object-side surface and a convex image-side surface.

The second lens group LG2 may include a fourth lens 540, a fifth lens 550, and a sixth lens 560. The fourth lens 540 may have negative refractive power and may have a concave object-side surface and a concave image-side surface. The fifth lens 550 may have positive refractive power and may have a convex object-side surface and a convex image-side surface. The sixth lens 560 may have negative refractive power and may have a convex object-side surface and a concave image-side surface.

The second lens group LG2 may be configured to be movable in an optical axis direction. Therefore, the example imaging lens system 500 according to the fifth embodiment may enable auto focus adjustment (AF) and focus magnification adjustment (Zoom) of a camera module through movement of the second lens group LG2.

The example imaging lens system 500 may further include other lens elements in addition to the first lens 510 to the sixth lens 560. For example, the imaging lens system 500 may further include a filter (IF) and an imaging plane (IP). The filter (IF) may be disposed between the sixth lens 560 and the imaging plane (IP). The imaging plane (IP) may be formed in a position in which light incident from the first lens 510 to the sixth lens 560 forms an image. For example, the imaging plane (IP) may be formed on one surface of an image sensor (IS) of a camera module or on a lens element disposed inside the image sensor (IS).

The example imaging lens system 500 according to the fifth embodiment may capture images of close and distant objects. As an example, the imaging lens system 500 may generally capture an object located at a long distance. As another example, the imaging lens system 500 may change a position of the second lens group LG2 to capture an image of an object located at a relatively close distance (e.g., 100 mm).

FIG. 10 illustrates aberration characteristics of the example imaging lens system 500 according to the fifth embodiment. Tables 9 and 10 below illustrate lens characteristics and aspherical values of the example imaging lens system according to the fifth embodiment.

TABLE 9

| Surface | | Curvature | Thickness/ | Refractive | Abbe | Effective |
|---|---|---|---|---|---|---|
| No. | Component | Radius | Distance | Index | No. | Radius |
| S1 | 1st Lens | 4.3580 | 2.315 | 1.537 | 55.7 | 3.32 |
| S2 | | −12.6830 | 0.314 | | | 3.26 |
| S3 | 2nd Lens | 522.0074 | 0.300 | 1.644 | 23.5 | 2.89 |
| S4 | | 5.9997 | 0.773 | | | 2.61 |
| S5 | 3rd Lens | 12.2955 | 0.968 | 1.546 | 56.0 | 2.57 |
| S6 | | −7.1954 | 0.450 | | | 2.58 |
| S7 | | Infinity | AF | | | 2.11 |
| S8 | 4th Lens | −4.1141 | 0.315 | 1.570 | 37.4 | 1.99 |
| S9 | | 16.5678 | 0.621 | | | 1.70 |
| S10 | 5th Lens | 48.3769 | 0.594 | 1.677 | 19.2 | 1.68 |
| S11 | | −13.9168 | 2.394 | | | 1.71 |
| S12 | 6th Lens | 18.1715 | 0.476 | 1.546 | 56.0 | 2.42 |
| S13 | | 6.1159 | 1.590 | | | 2.73 |
| S14 | | Infinity | −AF | | | 3.78 |
| S15 | | Infinity | 0.000 | | | 3.54 |
| S16 | Filter | Infinity | 0.210 | 1.518 | 64.2 | 3.54 |
| S17 | | Infinity | 0.795 | | | 3.59 |
| S18 | Imaging | | 0.005 | | | |
| | Plane | | | | | |

TABLE 10

| Surface | | | | | | |
|---|---|---|---|---|---|---|
| No. | S1 | S2 | S3 | S4 | S5 | S6 |
| K | −4.708E−01 | 3.920E+00 | −9.000E+01 | 2.379E+00 | −6.071E+00 | 4.374E−01 |
| A | 7.681E−04 | 1.359E−02 | 2.488E−02 | 1.809E−02 | 1.593E−04 | 3.071E−03 |
| B | −8.562E−04 | −1.825E−02 | −6.008E−02 | −5.680E−02 | 1.227E−03 | −1.168E−02 |
| C | 8.893E−04 | 1.504E−02 | 6.171E−02 | 6.734E−02 | −1.361E−02 | 1.690E−02 |
| D | −6.616E−04 | −8.321E−03 | −3.974E−02 | −5.145E−02 | 2.416E−02 | −1.649E−02 |
| E | 3.273E−04 | 3.340E−03 | 1.846E−02 | 2.981E−02 | −2.329E−02 | 1.146E−02 |
| F | −1.116E−04 | −9.961E−04 | −6.467E−03 | −1.353E−02 | 1.473E−02 | −5.769E−03 |
| G | 2.688E−05 | 2.219E−04 | 1.725E−03 | 4.793E−03 | −6.507E−03 | 2.114E−03 |
| H | −4.637E−06 | −3.686E−05 | −3.496E−04 | −1.308E−03 | 2.060E−03 | −5.647E−04 |
| J | 5.742E−07 | 4.537E−06 | 5.331E−05 | 2.706E−04 | −4.696E−04 | 1.092E−04 |
| L | −5.053E−08 | −4.073E−07 | −6.003E−06 | −4.150E−05 | 7.642E−05 | −1.502E−05 |
| M | 3.079E−09 | 2.589E−08 | 4.836E−07 | 4.554E−06 | −8.646E−06 | 1.427E−06 |
| N | −1.233E−10 | −1.103E−09 | −2.634E−08 | −3.371E−07 | 6.453E−07 | −8.831E−08 |
| O | 2.914E−12 | 2.822E−11 | 8.683E−10 | 1.504E−08 | −2.852E−08 | 3.180E−09 |
| P | −3.075E−14 | −3.279E−13 | −1.308E−11 | −3.050E−10 | 5.650E−10 | −5.000E−11 |

| Surface | | | | | | |
|---|---|---|---|---|---|---|
| No. | S8 | S9 | S10 | S11 | S12 | S13 |
| K | −5.981E+01 | 4.940E+01 | 5.397E+01 | −8.722E+01 | −3.406E+00 | 2.553E+00 |
| A | −1.052E−02 | 7.729E−02 | −2.345E−02 | −2.763E−02 | −4.419E−02 | −4.444E−02 |
| B | 8.142E−02 | −1.732E−02 | 1.015E−02 | 1.184E−02 | 1.175E−02 | 4.169E−03 |
| C | −1.311E−01 | −5.197E−02 | −1.070E−01 | −5.110E−02 | −2.186E−02 | 1.004E−03 |
| D | 1.254E−01 | 1.293E−01 | 4.638E−01 | 1.683E−01 | 4.117E−02 | 2.104E−03 |
| E | −6.280E−02 | −1.832E−01 | −1.161E+00 | −3.711E−01 | −4.692E−02 | −4.338E−03 |
| F | −5.750E−03 | 2.039E−01 | 1.899E+00 | 5.602E−01 | 3.503E−02 | 3.542E−03 |
| G | 3.517E−02 | −1.958E−01 | −2.144E+00 | −5.919E−01 | −1.805E−02 | −1.743E−03 |
| H | −2.896E−02 | 1.570E−01 | 1.717E+00 | 4.443E−01 | 6.585E−03 | 5.729E−04 |
| J | 1.368E−02 | −9.729E−02 | −9.838E−01 | −2.383E−01 | −1.717E−03 | −1.304E−04 |
| L | −4.227E−03 | 4.378E−02 | 4.010E−01 | 9.067E−02 | 3.178E−04 | 2.070E−05 |
| M | 8.709E−04 | −1.362E−02 | −1.136E−01 | −2.393E−02 | −4.080E−05 | −2.251E−06 |
| N | −1.158E−04 | 2.761E−03 | 2.124E−02 | 4.166E−03 | 3.454E−06 | 1.600E−07 |
| O | 9.025E−06 | −3.270E−04 | −2.360E−03 | −4.305E−04 | −1.735E−07 | −6.707E−09 |
| P | −3.135E−07 | 1.712E−05 | 1.179E−04 | 2.000E−05 | 3.915E−09 | 1.257E−10 |

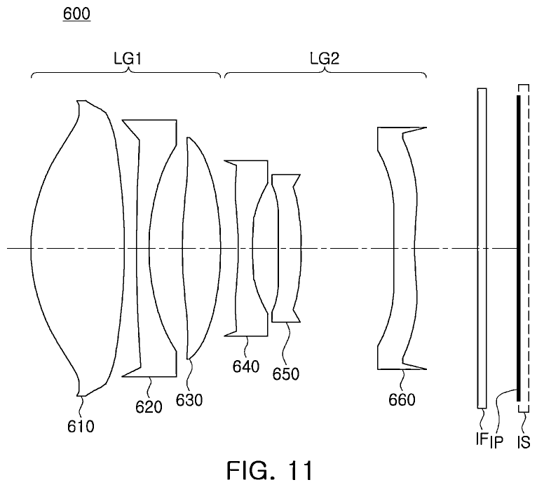

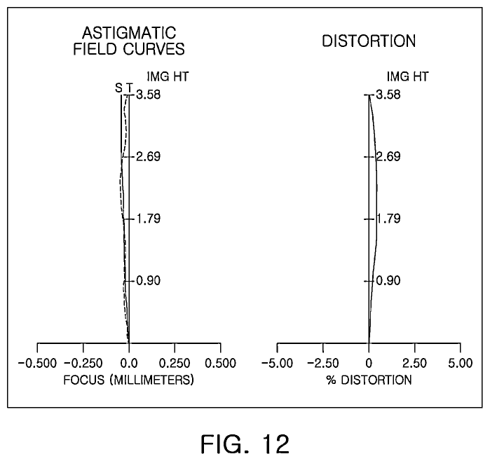

An example imaging lens system according to a sixth embodiment will be described with reference to FIGS. 11 and 12.

An example imaging lens system 600 may include a plurality of lens groups. For example, the imaging lens system 600 may include a first lens group (LG1) and a second lens group (LG2). The first lens group (LG1) and the second lens group (LG2) may be arranged sequentially from an object side toward an imaging plane. The first lens group (LG1) and the second lens group (LG2) may include one or more lenses. For example, the first lens group (LG1) and the second lens group (LG2) may each be comprised of three lenses.

The first lens group (LG1) may include a first lens 610, a second lens 620, and a third lens 630. The first lens 610 may have positive refractive power and may have a convex object-side surface and a convex image-side surface. The second lens 620 may have a negative refractive power and may have a convex object-side surface and a concave image-side surface. The third lens 630 may have positive refractive power and may have a convex object-side surface and a convex image-side surface.

The second lens group LG2 may include a fourth lens 640, a fifth lens 650, and a sixth lens 660. The fourth lens 640 may have negative refractive power and may have a concave object-side surface and a concave image-side surface. The fifth lens 650 may have positive refractive power and may have a convex object-side surface and a convex image-side surface. The sixth lens 660 may have negative refractive power and may have a convex object-side surface and a concave image-side surface.

The second lens group LG2 may be configured to be movable in an optical axis direction. Therefore, the example imaging lens system 600 according to the sixth embodiment can enable auto focus adjustment (AF) and focus magnification adjustment (Zoom) of a camera module through movement of the second lens group LG2.

The example imaging lens system 600 according to the sixth embodiment can capture images of close and distant objects. As an example, the imaging lens system 600 can generally capture an object located at a long distance. As another example, the imaging lens system 600 may change the position of the second lens group LG2 to capture an image of an object located at a relatively short distance (e.g., 100 mm).

FIG. 12 illustrates aberration characteristics of the example imaging lens system 600 according to the sixth embodiment. Tables 11 and 12 below illustrate lens characteristics and aspherical values of the example imaging lens system according to the sixth embodiment.

TABLE 11

| Surface | | Curvature | Thickness/ | Refractive | Abbe | Effective |
|---|---|---|---|---|---|---|
| No. | Component | Radius | Distance | Index | No. | Radius |
| S1 | 1st Lens | 4.3413 | 2.304 | 1.537 | 55.7 | 3.32 |
| S2 | | −12.6341 | 0.325 | | | 3.26 |
| S3 | 2nd Lens | 346.8944 | 0.300 | 1.644 | 23.5 | 2.87 |
| S4 | | 5.9294 | 0.819 | | | 2.59 |
| S5 | 3rd Lens | 11.8190 | 0.949 | 1.546 | 56.0 | 2.54 |
| S6 | | −7.3182 | 0.450 | | | 2.53 |
| S7 | | Infinity | 0.000 | | | 2.09 |
| S8 | 4th Lens | −4.1391 | 0.350 | 1.570 | 37.4 | 1.97 |
| S9 | | 15.6551 | 0.634 | | | 1.68 |
| S10 | 5th Lens | 35.7748 | 0.564 | 1.677 | 19.2 | 1.64 |
| S11 | | −16.8216 | 2.308 | | | 1.67 |
| S12 | 6th Lens | 13.8519 | 0.519 | 1.546 | 56.0 | 2.46 |
| S13 | | 5.8280 | 1.588 | | | 2.72 |
| S14 | | Infinity | 0.000 | | | 3.77 |
| S15 | | Infinity | 0.000 | | | 3.54 |
| S16 | Filter | Infinity | 0.210 | 1.518 | 64.2 | 3.54 |
| S17 | | Infinity | 0.797 | | | 3.59 |
| S18 | Imaging | | 0.005 | | | |
| | Plane | | | | | |

TABLE 12

| Surface | | | | | | |
|---|---|---|---|---|---|---|
| No. | S1 | S2 | S3 | S4 | S5 | S6 |
| K | −4.696E−01 | 3.921E+00 | −9.000E+01 | 2.363E+00 | −5.593E+00 | 3.663E−01 |
| A | 4.056E−04 | 1.034E−02 | 1.677E−02 | 1.215E−02 | −2.052E−03 | 2.572E−03 |
| B | −6.586E−05 | −1.049E−02 | −3.619E−02 | −3.842E−02 | 8.820E−03 | −1.145E−02 |
| C | −7.090E−05 | 6.499E−03 | 2.989E−02 | 4.296E−02 | −2.750E−02 | 1.802E−02 |
| D | 9.137E−05 | −2.631E−03 | −1.429E−02 | −3.344E−02 | 4.035E−02 | −1.888E−02 |
| E | −6.979E−05 | 7.863E−04 | 4.822E−03 | 2.228E−02 | −3.599E−02 | 1.388E−02 |
| F | 3.334E−05 | −1.852E−04 | −1.327E−03 | −1.235E−02 | 2.164E−02 | −7.297E−03 |
| G | −1.052E−05 | 3.535E−05 | 3.326E−04 | 5.304E−03 | −9.170E−03 | 2.775E−03 |
| H | 2.271E−06 | −5.466E−06 | −7.622E−05 | −1.696E−03 | 2.794E−03 | −7.681E−04 |
| J | −3.412E−07 | 6.700E−07 | 1.452E−05 | 3.952E−04 | −6.150E−04 | 1.544E−04 |
| L | 3.570E−08 | −6.268E−08 | −2.083E−06 | −6.586E−05 | 9.694E−05 | −2.227E−05 |
| M | −2.552E−09 | 4.259E−09 | 2.100E−07 | 7.626E−06 | −1.067E−05 | 2.242E−06 |
| N | 1.188E−10 | −1.961E−10 | −1.389E−08 | −5.822E−07 | 7.777E−07 | −1.494E−07 |
| O | −3.251E−12 | 5.440E−12 | 5.401E−10 | 2.633E−08 | −3.376E−08 | 5.912E−09 |
| P | 3.962E−14 | −6.832E−14 | −9.338E−12 | −5.343E−10 | 6.599E−10 | −1.052E−10 |

| Surface | | | | | | |
|---|---|---|---|---|---|---|
| No. | S8 | S9 | S10 | S11 | S12 | S13 |
| K | −5.957E+01 | 5.490E+01 | 9.000E+01 | −8.821E+01 | 1.235E+01 | 2.550E+00 |
| A | −1.105E−02 | 7.457E−02 | −1.816E−02 | −3.058E−02 | −3.813E−02 | −3.944E−02 |
| B | 8.154E−02 | 4.542E−03 | −4.393E−02 | 4.964E−02 | −2.103E−03 | −1.893E−03 |
| C | −1.281E−01 | −1.343E−01 | 2.095E−01 | −2.775E−01 | 6.543E−03 | 8.956E−03 |
| D | 1.173E−01 | 3.267E−01 | −6.632E−01 | 9.575E−01 | 3.513E−03 | −5.762E−03 |
| E | −4.799E−02 | −4.646E−01 | 1.463E+00 | −2.143E+00 | −1.352E−02 | 1.227E−03 |
| F | −2.562E−02 | 4.175E−01 | −2.287E+00 | 3.267E+00 | 1.431E−02 | 6.862E−04 |
| G | 5.385E−02 | −2.206E−01 | 2.568E+00 | −3.498E+00 | −8.800E−03 | −6.676E−04 |
| H | −4.113E−02 | 3.740E−02 | −2.086E+00 | 2.675E+00 | 3.579E−03 | 2.754E−04 |
| J | 1.919E−02 | 3.660E−02 | 1.226E+00 | −1.469E+00 | −1.004E−03 | −7.027E−05 |
| L | −5.959E−03 | −3.278E−02 | −5.153E−01 | 5.741E−01 | 1.957E−04 | 1.194E−05 |
| M | 1.242E−03 | 1.324E−02 | 1.510E−01 | −1.560E−01 | −2.613E−05 | −1.359E−06 |
| N | −1.677E−04 | −3.076E−03 | −2.927E−02 | 2.799E−02 | 2.280E−06 | 9.983E−08 |
| O | 1.328E−05 | 3.979E−04 | 3.373E−03 | −2.983E−03 | −1.172E−07 | −4.291E−09 |
| P | −4.693E−07 | −2.237E−05 | −1.750E−04 | 1.429E−04 | 2.696E−09 | 8.208E−11 |

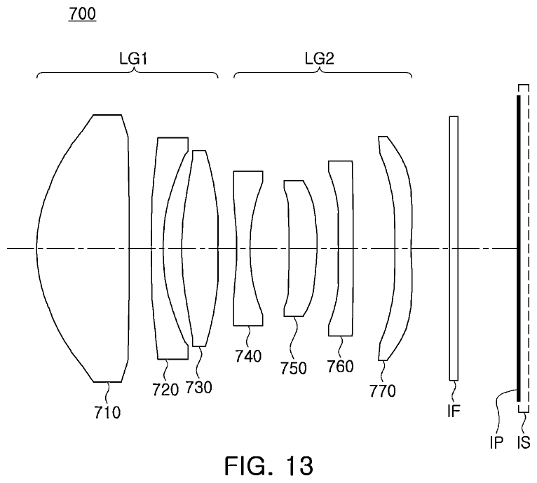

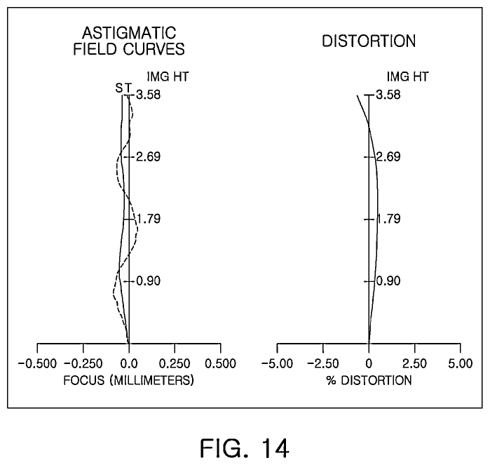

An example imaging lens system according to a seventh embodiment will be described with reference to FIGS. 13 and 14.

An example imaging lens system 700 may be comprised of a plurality of lens groups. For example, the imaging lens system 700 may include a first lens group (LG1) and a second lens group (LG2). The first lens group (LG1) and the second lens group (LG2) may be arranged sequentially from an object side toward an imaging plane. The first lens group (LG1) and the second lens group (LG2) may include one or more lenses. For example, the first lens group (LG1) may be comprised of three lenses, and the second lens group (LG2) may be comprised of four lenses.

The first lens group (LG1) may be comprised of a first lens 710, a second lens 720, and a third lens 730. The first lens 710 may have positive refractive power and may have a convex object-side surface and a convex image-side surface. The second lens 720 may have a negative refractive power and may have a convex object-side surface and a concave image-side surface. The third lens 730 may have positive refractive power and may have a convex object-side surface and a convex image-side surface.

The second lens group (LG2) may be comprised of a fourth lens 740, a fifth lens 750, a sixth lens 760, and a seventh lens 770. The fourth lens 740 may have negative refractive power and may have a convex object-side surface and a concave image-side surface. The fifth lens 750 may have positive refractive power and may have a concave object-side surface and a convex image-side surface. The sixth lens 760 may have negative refractive power and may have a concave object-side surface and a convex image-side surface. The seventh lens 770 may have negative refractive power and may have a convex object-side surface and a concave image-side surface.

The second lens group (LG2) may be configured to be movable in an optical axis direction. Therefore, the example imaging lens system 700 according to the seventh embodiment may enable auto focus adjustment (AF) and focus magnification adjustment (Zoom) of the camera module through movement of the second lens group (LG2).

The example imaging lens system 700 may further include other lens elements in addition to the first lens 710 to the sixth lens 760. For example, the imaging lens system 700 may further include a filter (IF) and an imaging plane (IP). The filter (IF) may be disposed between the sixth lens 760 and the imaging plane (IP). The imaging plane (IP) may be formed in a location in which light incident from the first 710 to the sixth lens 760 forms an image. For example, the imaging plane (IP) may be formed on one surface of an image sensor (IS) of a camera module or on a lens element disposed inside the image sensor (IS).

The example imaging lens system 700 according to the seventh embodiment can capture images of close and distant objects. As an example, the imaging lens system 700 can generally image an object located at a long distance. As another example, the example imaging lens system 700 may change the position of the second lens group (LG2) to capture an image of an object located at a relatively close distance (e.g., 100 mm).

FIG. 13 illustrates aberration characteristics of the example imaging lens system 700 according to the seventh embodiment. Tables 13 and 14 illustrate the lens characteristics and aspherical values of the example imaging lens system according to the seventh embodiment.

TABLE 13

| Surface | | Curvature | Thickness/ | Refractive | Abbe | Effective |
|---|---|---|---|---|---|---|
| No. | Component | Radius | Distance | Index | No. | Radius |
| S1 | 1st Lens | 4.0686 | 2.324 | 1.537 | 55.7 | 3.30 |
| S2 | | −56.5288 | 0.509 | | | 3.18 |
| S3 | 2nd Lens | 22.8003 | 0.306 | 1.677 | 19.2 | 2.74 |
| S4 | | 5.5609 | 0.472 | | | 2.46 |
| S5 | 3rd Lens | 7.1584 | 0.913 | 1.546 | 56.0 | 2.43 |
| S6 | | −11.0131 | 0.451 | | | 2.30 |
| S7 | | Infinity | 0.000 | | | 2.03 |
| S8 | 4th Lens | −4.1191 | 0.342 | 1.546 | 56.0 | 1.91 |
| S9 | | 31.2031 | 0.968 | | | 1.67 |
| S10 | 5th Lens | −35.5935 | 0.685 | 1.677 | 19.2 | 1.48 |
| S11 | | −9.4955 | 0.568 | | | 1.70 |
| S12 | 6th Lens | −8.9333 | 0.350 | 1.619 | 25.9 | 1.95 |
| S13 | | −13.4681 | 1.009 | | | 2.17 |
| S14 | 7th Lens | 26.2023 | 0.423 | 1.546 | 56.0 | 2.66 |
| S15 | | 8.0553 | 0.919 | | | 2.76 |
| S16 | | Infinity | 0.000 | | | 3.36 |
| S17 | | Infinity | 0.000 | | | 3.18 |
| S18 | Filter | Infinity | 0.210 | 1.518 | 64.2 | 3.18 |
| S19 | | Infinity | 1.516 | | | 3.23 |
| S20 | Imaging | | 0.004 | | | |
| | Plane | | | | | |

TABLE 14

| Surface | | | | | | | |
|---|---|---|---|---|---|---|---|
| No. | S1 | S2 | S3 | S4 | S5 | S6 | S8 |
| K | −3.643E−01 | −9.000E+01 | 3.180E+01 | 2.256E+00 | −9.179E+00 | 8.310E+00 | −4.121E+01 |
| A | 1.270E−03 | −7.365E−03 | −2.836E−02 | −2.260E−02 | 5.004E−06 | 6.952E−03 | 2.999E−02 |
| B | −3.404E−03 | 9.431E−03 | 4.832E−02 | 4.299E−02 | 1.487E−02 | −2.087E−02 | −1.792E−02 |
| C | 4.416E−03 | −5.797E−03 | −3.733E−02 | −2.477E−02 | −2.886E−02 | 3.941E−02 | 5.379E−02 |
| D | −3.390E−03 | 2.546E−03 | 1.774E−02 | −3.878E−03 | 3.679E−02 | −5.115E−02 | −1.329E−01 |
| E | 1.706E−03 | −9.173E−04 | −6.019E−03 | 1.599E−02 | −3.434E−02 | 4.541E−02 | 1.967E−01 |
| F | −5.932E−04 | 2.787E−04 | 1.648E−03 | −1.345E−02 | 2.268E−02 | −2.825E−02 | −1.900E−01 |
| G | 1.466E−04 | −6.874E−05 | −3.965E−04 | 7.017E−03 | −1.055E−02 | 1.255E−02 | 1.260E−01 |
| H | −2.616E−05 | 1.312E−05 | 8.288E−05 | −2.573E−03 | 3.474E−03 | −4.025E−03 | −5.862E−02 |
| J | 3.378E−06 | −1.869E−06 | −1.382E−05 | 6.788E−04 | −8.103E−04 | 9.329E−04 | 1.920E−02 |
| L | −3.130E−07 | 1.931E−07 | 1.672E−06 | −1.276E−04 | 1.327E−04 | −1.547E−04 | −4.355E−03 |
| M | 2.028E−08 | −1.399E−08 | −1.348E−07 | 1.660E−05 | −1.489E−05 | 1.788E−05 | 6.565E−04 |
| N | −8.724E−10 | 6.710E−10 | 6.448E−09 | −1.414E−06 | 1.093E−06 | −1.365E−06 | −6.031E−05 |
| O | 2.240E−11 | −1.914E−11 | −1.431E−10 | 7.066E−08 | −4.745E−08 | 6.169E−08 | 2.763E−06 |
| P | −2.597E−13 | 2.454E−13 | 3.783E−13 | −1.566E−09 | 9.316E−10 | −1.242E−09 | −3.031E−08 |

| Surface | | | | | | | |
|---|---|---|---|---|---|---|---|
| No. | S9 | S10 | S11 | S12 | S13 | S14 | S15 |
| K | 4.114E+01 | −9.000E+01 | 1.822E+01 | 1.121E+01 | −7.700E+01 | 5.658E+01 | 7.128E+00 |
| A | 1.029E−01 | −3.903E−03 | −9.170E−03 | 2.197E−02 | 1.840E−02 | −3.924E−02 | −4.188E−02 |
| B | −1.169E−01 | −1.164E−02 | 1.998E−02 | −4.614E−02 | −3.855E−02 | 1.264E−02 | −1.429E−03 |
| C | 3.715E−01 | 1.630E−03 | −1.355E−01 | 8.300E−02 | 7.455E−02 | −1.439E−02 | 2.191E−02 |
| D | −1.147E+00 | −8.741E−03 | 3.924E−01 | −1.491E−01 | −1.175E−01 | 1.964E−02 | −3.264E−02 |
| E | 2.465E+00 | 1.505E−01 | −7.595E−01 | 2.055E−01 | 1.331E−01 | −1.805E−02 | 2.958E−02 |
| F | −3.679E+00 | −5.923E−01 | 1.047E+00 | −2.029E−01 | −1.061E−01 | 1.127E−02 | −1.815E−02 |
| G | 3.898E+00 | 1.224E+00 | −1.047E+00 | 1.440E−01 | 6.036E−02 | −4.964E−03 | 7.816E−03 |
| H | −2.975E+00 | −1.582E+00 | 7.651E−01 | −7.410E−02 | −2.481E−02 | 1.572E−03 | −2.401E−03 |
| J | 1.640E+00 | 1.362E+00 | −4.070E−01 | 2.764E−02 | 7.376E−03 | −3.594E−04 | 5.286E−04 |
| L | −6.463E−01 | −7.969E−01 | 1.557E−01 | −7.399E−03 | −1.571E−03 | 5.878E−05 | −8.274E−05 |
| M | 1.775E−01 | 3.142E−01 | −4.168E−02 | 1.385E−03 | 2.336E−04 | −6.696E−06 | 8.986E−06 |
| N | −3.226E−02 | −8.002E−02 | 7.403E−03 | −1.721E−04 | −2.305E−05 | 5.039E−07 | −6.434E−07 |
| O | 3.483E−03 | 1.190E−02 | −7.832E−04 | 1.275E−05 | 1.357E−06 | −2.249E−08 | 2.730E−08 |
| P | −1.691E−04 | −7.862E−04 | 3.734E−05 | −4.257E−07 | −3.608E−08 | 4.501E−10 | −5.198E−10 |

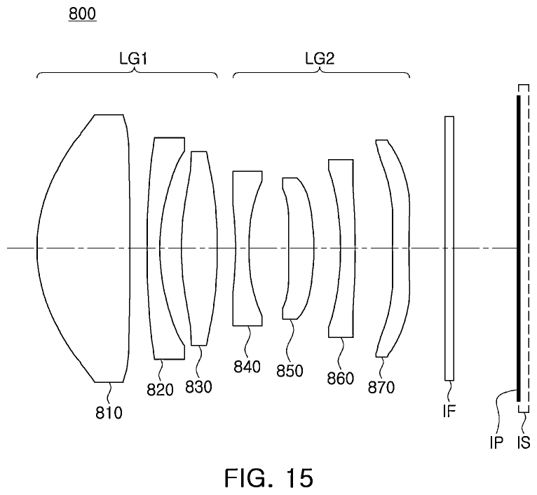

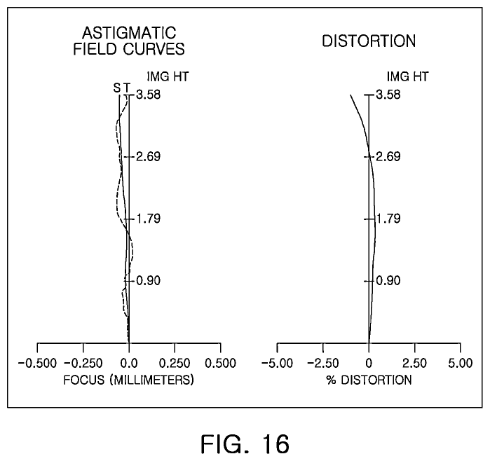

An example imaging lens system according to an eighth embodiment will be described with reference to FIGS. 15 and 16.

An example imaging lens system 800 may be comprised of a plurality of lens groups. For example, the imaging lens system 800 may include a first lens group (LG1) and a second lens group (LG2). The first lens group LG1 and the second lens group LG2 may be arranged sequentially from an object side toward an imaging plane. The first lens group (LG1) and the second lens group (LG2) may include one or more lenses. For example, the first lens group (LG1) may be comprised of three lenses, and the second lens group (LG2) may be comprised of four lenses.

The first lens group (LG1) may be comprised of a first lens 810, a second lens 820, and a third lens 830. The first lens 810 may have positive refractive power and may have a convex object-side surface and a convex image-side surface. The second lens 820 may have negative refractive power and may have a convex object-side surface and a concave image-side surface. The third lens 830 may have positive refractive power and may have a convex object-side surface and a convex image-side surface.

The second lens group (LG2) may be comprised of a fourth lens 840, a fifth lens 850, a sixth lens 860, and a seventh lens 870. The fourth lens 840 may have negative refractive power and may have a concave object-side surface and a concave image-side surface. The fifth lens 850 may have positive refractive power and may have a concave object-side surface and a convex image-side surface. The sixth lens 860 may have negative refractive power and may have a concave object-side surface and a convex image-side surface. The seventh lens 870 may have negative refractive power and may have a convex object-side surface and a concave image-side surface.

The second lens group (LG2) may be configured to be movable in an optical axis direction. Therefore, the imaging lens system 800 according to the eighth embodiment may enable auto focus adjustment (AF) and focus magnification adjustment (Zoom) of a camera module through movement of the second lens group (LG2).

The example imaging lens system 800 may further include other lens elements in addition to the first lens 810 to the sixth lens 860. For example, the imaging lens system 800 may further include a filter (IF) and an imaging plane (IP). The filter (IF) may be disposed between the sixth lens 860 and the imaging plane (IP). The imaging plane (IP) may be formed in a location in which light incident from the first lens 810 to the sixth lens 860 forms an image. For example, the imaging plane (IP) may be formed on one surface of an image sensor (IS) of a camera module or on a lens element disposed inside the image sensor (IS).

The example imaging lens system 800 according to the eighth embodiment can capture images of close and distant objects. As an example, the imaging lens system 800 can generally capture an object located at a long distance. As another example, the example imaging lens system 800 may change the position of the second lens group (LG2) to capture an image of an object located at a relatively close distance (e.g., 100 mm).

FIG. 15 illustrates aberration characteristics of the example imaging lens system 800 according to the eighth embodiment. Tables 15 and 16 illustrate lens characteristics and aspherical values of the example imaging lens system according to the eighth embodiment.

TABLE 15

| Surface | | Curvature | Thickness/ | Refractive | Abbe | Effective |
|---|---|---|---|---|---|---|
| No. | Component | Radius | Distance | Index | No. | Radius |
| S1 | 1st Lens | 4.0157 | 2.336 | 1.537 | 55.7 | 3.30 |
| S2 | | −69.9602 | 0.415 | | | 3.18 |
| S3 | 2nd Lens | 22.5285 | 0.300 | 1.677 | 19.2 | 2.74 |
| S4 | | 5.5503 | 0.530 | | | 2.46 |
| S5 | 3rd Lens | 7.1655 | 0.927 | 1.546 | 56.0 | 2.43 |
| S6 | | −11.1340 | 0.450 | | | 2.30 |
| S7 | | Infinity | 0.000 | | | 2.03 |
| S8 | 4th Lens | −4.1369 | 0.325 | 1.546 | 56.0 | 1.91 |
| S9 | | 30.9489 | 0.991 | | | 1.67 |
| S10 | 5th Lens | −32.6966 | 0.615 | 1.677 | 19.2 | 1.48 |
| S11 | | −9.1727 | 0.656 | | | 1.70 |
| S12 | 6th Lens | −8.8639 | 0.386 | 1.619 | 25.9 | 1.95 |
| S13 | | −12.4891 | 0.928 | | | 2.17 |
| S14 | 7th Lens | 29.2919 | 0.385 | 1.546 | 56.0 | 2.66 |
| S15 | | 8.0408 | 0.919 | | | 2.76 |
| S16 | | Infinity | 0.000 | | | 3.36 |
| S17 | | Infinity | 0.000 | | | 3.18 |
| S18 | Filter | Infinity | 0.210 | 1.518 | 64.2 | 3.18 |
| S19 | | Infinity | 1.600 | | | 3.23 |
| S20 | Imaging | | −0.003 | | | |
| | Plane | | | | | |

TABLE 16

| Surface | | | | | | | |
|---|---|---|---|---|---|---|---|
| No. | S1 | S2 | S3 | S4 | S5 | S6 | S8 |
| K | −3.587E−01 | −8.586E+01 | 3.206E+01 | 2.250E+00 | −9.272E+00 | 8.237E+00 | −4.160E+01 |
| A | 1.178E−04 | −8.148E−03 | −2.723E−02 | −2.137E−02 | 9.592E−04 | 6.784E−03 | 2.067E−02 |
| B | −2.836E−04 | 1.033E−02 | 4.432E−02 | 3.779E−02 | 5.101E−03 | −2.857E−02 | 5.778E−02 |
| C | 3.590E−04 | −5.831E−03 | −2.914E−02 | −1.493E−02 | −4.313E−03 | 6.470E−02 | −2.468E−01 |
| D | −2.141E−04 | 1.996E−03 | 7.781E−03 | −1.459E−02 | 2.023E−03 | −9.166E−02 | 5.967E−01 |
| E | 7.159E−05 | −4.417E−04 | 1.665E−03 | 2.253E−02 | −2.421E−03 | 8.599E−02 | −9.695E−01 |
| F | −1.223E−05 | 6.313E−05 | −2.331E−03 | −1.508E−02 | 2.703E−03 | −5.597E−02 | 1.093E+00 |
| G | 2.290E−09 | −5.867E−06 | 1.037E−03 | 6.478E−03 | −1.768E−03 | 2.602E−02 | −8.718E−01 |
| H | 5.058E−07 | 4.894E−07 | −2.839E−04 | −1.955E−03 | 7.189E−04 | −8.771E−03 | 4.990E−01 |
| J | −1.251E−07 | −7.717E−08 | 5.328E−05 | 4.261E−04 | −1.911E−04 | 2.152E−03 | −2.055E−01 |
| L | 1.651E−08 | 1.319E−08 | −7.040E−06 | −6.695E−05 | 3.371E−05 | −3.807E−04 | 6.036E−02 |
| M | −1.341E−09 | −1.436E−09 | 6.482E−07 | 7.388E−06 | −3.893E−06 | 4.736E−05 | −1.233E−02 |
| N | 6.705E−11 | 9.206E−11 | −3.976E−08 | −5.406E−07 | 2.802E−07 | −3.935E−06 | 1.665E−03 |
| O | −1.898E−12 | −3.231E−12 | 1.464E−09 | 2.340E−08 | −1.124E−08 | 1.961E−07 | −1.336E−04 |
| P | 2.327E−14 | 4.828E−14 | −2.448E−11 | −4.492E−10 | 1.867E−10 | −4.437E−09 | 4.821E−06 |

| Surface | | | | | | | |
|---|---|---|---|---|---|---|---|
| No. | S9 | S10 | S11 | S12 | S13 | S14 | S15 |
| K | 5.768E+01 | 2.241E+00 | 1.747E+01 | 1.016E+01 | −8.012E+01 | 8.432E+01 | 7.249E+00 |
| A | 8.695E−02 | 1.105E−02 | −8.556E−03 | 5.018E−03 | 2.890E−03 | −5.011E−02 | −4.887E−02 |
| B | 3.228E−02 | −2.558E−01 | −1.842E−03 | 1.574E−02 | 2.218E−02 | 4.120E−02 | 7.663E−03 |
| C | −3.581E−01 | 1.645E+00 | −3.551E−02 | −6.897E−02 | −7.659E−02 | −6.148E−02 | 1.413E−02 |
| D | 1.059E+00 | −6.470E+00 | 1.159E−01 | 1.318E−01 | 1.418E−01 | 7.158E−02 | −2.945E−02 |
| E | −1.977E+00 | 1.662E+01 | −2.099E−01 | −1.699E−01 | −1.718E−01 | −5.687E−02 | 3.043E−02 |
| F | 2.553E+00 | −2.931E+01 | 2.479E−01 | 1.577E−01 | 1.437E−01 | 3.146E−02 | −2.009E−02 |
| G | −2.357E+00 | 3.659E+01 | −2.018E−01 | −1.071E−01 | −8.501E−02 | −1.242E−02 | 9.058E−03 |
| H | 1.580E+00 | −3.283E+01 | 1.165E−01 | 5.335E−02 | 3.602E−02 | 3.552E−03 | −2.871E−03 |
| J | −7.713E−01 | 2.124E+01 | −4.828E−02 | −1.944E−02 | −1.097E−02 | −7.378E−04 | 6.468E−04 |
| L | 2.717E−01 | −9.821E+00 | 1.439E−02 | 5.106E−03 | 2.377E−03 | 1.103E−04 | −1.030E−04 |
| M | −6.731E−02 | 3.164E+00 | −3.043E−03 | −9.403E−04 | −3.576E−04 | −1.156E−05 | 1.135E−05 |
| N | 1.114E−02 | −6.743E−01 | 4.389E−04 | 1.151E−04 | 3.547E−05 | 8.068E−07 | −8.228E−07 |
| O | −1.106E−03 | 8.543E−02 | −3.921E−05 | −8.396E−06 | −2.084E−06 | −3.364E−08 | 3.531E−08 |
| P | 4.990E−05 | −4.870E−03 | 1.652E−06 | 2.765E−07 | 5.495E−08 | 6.337E−10 | −6.798E−10 |

Table 17 below illustrates characteristic values of the example imaging lens system according to the first to eighth embodiments.

TABLE 17

| | 1^{st} | 2^{nd} | 3^{rd} | 4^{th} |
|---|---|---|---|---|
| | Embodiment | Embodiment | Embodiment | Embodiment |
| TTL | 12.120 | 12.120 | 12.121 | 12.129 |
| AF | 0.600 | 0.600 | 0.599 | 0.600 |
| L | 100.000 | 100.000 | 100.000 | 100.000 |
| fG1 | 6.502 | 6.502 | 6.448 | 6.462 |
| fG2 | −6.297 | −6.297 | −5.562 | −5.397 |
| f | 12.300 | 12.300 | 12.300 | 12.300 |
| f number | 1.894 | 1.859 | 1.855 | 1.857 |
| ImgHT | 7.168 | 7.168 | 7.168 | 7.168 |
| HFOV | 32.367 | 32.453 | 32.652 | 32.428 |
| f1 | 6.004 | 5.836 | 6.245 | 6.202 |
| f2 | −7.449 | −6.831 | −7.220 | −9.623 |
| f3 | 7.682 | 7.388 | 6.963 | 9.385 |
| f4 | −8.711 | −8.694 | −6.872 | −6.499 |
| f5 | 24.896 | 13.798 | 36.381 | 25.132 |
| f6 | −13.269 | −9.314 | −20.530 | −18.526 |
| f7 | — | — | — | — |
| | 5^{th} | 6^{th} | 7^{th} | 8^{th} |
| | Embodiment | Embodiment | Embodiment | Embodiment |
| TTL | 12.115 | 12.115 | 11.966 | 11.973 |
| AF | 0.600 | 0.600 | 0.600 | 0.600 |
| L | 100.000 | 100.000 | 100.000 | 100.000 |
| fG1 | 6.434 | 6.428 | 6.419 | 6.430 |
| fG2 | −5.367 | −5.403 | −5.501 | −5.583 |
| f | 12.345 | 12.345 | 12.420 | 12.420 |
| f number | 1.859 | 1.859 | 1.882 | 1.883 |
| ImgHT | 7.168 | 7.168 | 7.168 | 7.168 |
| HFOV | 32.356 | 32.356 | 32.380 | 32.519 |
| f1 | 6.346 | 6.321 | 7.169 | 7.156 |
| f2 | −9.426 | −9.370 | −10.943 | −10.958 |
| f3 | 8.465 | 8.429 | 8.093 | 8.133 |
| f4 | −5.751 | −5.708 | −6.644 | −6.664 |
| f5 | 16.027 | 16.975 | 18.930 | 18.637 |
| f6 | −17.129 | −18.865 | −44.186 | −51.449 |
| f7 | — | — | −21.487 | −20.437 |

According to the examples of the first to eighth embodiments, the imaging lens system according to the one or more embodiments may have unique lens characteristics. For example, a focal length of a first lens is determined in the range of 5.0 mm to 8.0 mm, a focal length of a second lens is determined in the range of −12.0 mm to −6.0 mm, a focal length of a third lens is determined in the range of 6.0 mm to 10.0 mm, a focal length of a fourth lens is determined in the range of −10.0 mm to −4.0 mm, a focal length of a fifth lens is determined in the range of 10.0 mm to 40.0 mm, and a focal length of a seventh lens is determined in the range of −24.0 mm to −18.0 mm. A focal length of a sixth lens may vary depending on the number of lenses constituting an imaging lens system. For example, in an imaging lens system comprised of six elements, a focal length of a sixth lens is determined in the range of −24 mm to −8.0 mm, and an imaging lens system comprised of seven elements, a focal length of a sixth lens is determined in the range of −60 mm to −40.0 mm.

Tables 18 to 21 below illustrate conditional expression values of the example imaging lens system according to the first to eighth embodiments.

TABLE 18

| | 1^{st} | 2^{nd} | 3^{rd} | 4^{th} |
|---|---|---|---|---|
| | Embodiment | Embodiment | Embodiment | Embodiment |
| f/(SD1*2) | 1.894 | 1.859 | 1.851 | 1.850 |
| \|fG1/fG2\| | 1.033 | 1.033 | 1.159 | 1.197 |
| TTL/f | 0.985 | 0.985 | 0.985 | 0.986 |
| \|fG2²/ | 0.663 | 0.663 | 0.657 | 0.660 |
| (L − fG2)\|/AF | | | | |
| TTL/ | 0.845 | 0.845 | 0.845 | 0.846 |
| (ImgHT*2) | | | | |
| fG1/f1 | 1.083 | 1.114 | 1.033 | 1.042 |
| fG2/f4 | 0.723 | 0.724 | 0.809 | 0.830 |
| fG1/f | 0.529 | 0.529 | 0.524 | 0.525 |
| SD1/SD7 | 1.768 | 1.729 | 1.784 | 1.723 |
| | 5^{th} | 6^{th} | 7^{th} | 8^{th} |
| | Embodiment | Embodiment | Embodiment | Embodiment |
| f/(SD1*2) | 1.859 | 1.859 | 1.882 | 1.882 |
| \|fG1/fG2\| | 1.199 | 1.190 | 1.167 | 1.152 |
| TTL/f | 0.981 | 0.981 | 0.963 | 0.964 |
| \|fG2²/ | 0.655 | 0.653 | 0.651 | 0.653 |
| (L − fG2)\|/AF | | | | |
| TTL/ | 0.845 | 0.845 | 0.835 | 0.835 |
| (ImgHT*2) | | | | |
| fG1/fG1F | 1.014 | 1.017 | 0.895 | 0.899 |
| fG2/fG2F | 0.933 | 0.947 | 0.828 | 0.838 |
| fG1/f | 0.521 | 0.521 | 0.517 | 0.518 |
| SD1/SD7 | 1.671 | 1.686 | 1.725 | 1.725 |

TABLE 19

| | 1^{st} | 2^{nd} | 3^{rd} | 4^{th} |
|---|---|---|---|---|
| | Embodiment | Embodiment | Embodiment | Embodiment |
| fG1F/fG2F | −0.689 | −0.671 | −0.909 | −0.954 |
| fG1F/fG1R | 0.782 | 0.790 | 0.897 | 0.661 |
| fG2F/fG2R | 0.656 | 0.933 | 0.335 | 0.351 |
| fG1R/fG2F | −0.882 | −0.850 | −1.013 | −1.444 |
| fG1R/fG2R | −0.579 | −0.793 | −0.339 | −0.507 |
| | 5^{th} | 6^{th} | 7^{th} | 8^{th} |
| | Embodiment | Embodiment | Embodiment | Embodiment |
| fG1F/fG2F | −1.103 | −1.107 | −1.079 | −1.074 |
| fG1F/fG1R | 0.750 | 0.750 | 0.886 | 0.880 |
| fG2F/fG2R | 0.336 | 0.303 | 0.309 | 0.326 |
| fG1R/fG2F | −1.472 | −1.477 | −1.218 | −1.220 |
| fG1R/fG2R | −0.494 | −0.447 | −0.377 | −0.398 |

TABLE 20

| | 1^{st} | 2^{nd} | 3^{rd} | 4^{th} |
|---|---|---|---|---|
| | Embodiment | Embodiment | Embodiment | Embodiment |
| f1/f4 | −0.689 | −0.671 | −0.909 | −0.954 |
| f1/f3 | 0.782 | 0.790 | 0.897 | 0.661 |
| f3/f4 | −0.882 | −0.850 | −1.013 | −1.444 |
| f3/f6 | −0.579 | −0.793 | −0.339 | −0.507 |
| f3/f7 | — | — | — | — |
| f4/f6 | 0.656 | 0.933 | 0.335 | 0.351 |
| f4/f7 | — | — | — | — |
| | 5^{th} | 6^{th} | 7^{th} | 8^{th} |
| | Embodiment | Embodiment | Embodiment | Embodiment |
| f1/f4 | −1.103 | −1.107 | −1.079 | −1.074 |
| f1/f3 | 0.750 | 0.750 | 0.886 | 0.880 |
| f3/f4 | −1.472 | −1.477 | −1.218 | −1.220 |
| f3/f6 | −0.494 | −0.447 | −0.183 | −0.158 |
| f3/f7 | — | — | −0.377 | −0.398 |
| f4/f6 | 0.336 | 0.303 | 0.150 | 0.130 |
| f4/f7 | — | — | 0.309 | 0.326 |

TABLE 21

| | 1^{st} | 2^{nd} | 3^{rd} | 4^{th} |
|---|---|---|---|---|
| | Embodiment | Embodiment | Embodiment | Embodiment |
| R1/R5 | 0.493 | 0.570 | 0.635 | 0.431 |
| R1/R6 | −0.521 | −0.506 | −0.533 | −0.433 |
| R1/R7 | −1.119 | −1.256 | −0.848 | −1.065 |
| R2/R5 | −1.474 | −1.363 | −2.009 | −1.215 |
| R2/R6 | 1.557 | 1.210 | 1.688 | 1.220 |
| R5/R7 | −2.269 | −2.203 | −1.337 | −2.470 |
| R6/R7 | 2.148 | 2.481 | 1.591 | 2.460 |
| | 5^{th} | 6^{th} | 7^{th} | 8^{th} |
| | Embodiment | Embodiment | Embodiment | Embodiment |
| R1/R5 | 0.354 | 0.367 | 0.568 | 0.560 |
| R1/R6 | −0.606 | −0.593 | −0.369 | −0.361 |
| R1/R7 | −1.059 | −1.049 | −0.988 | −0.971 |
| R2/R5 | −1.032 | −1.069 | −7.897 | −9.763 |
| R2/R6 | 1.763 | 1.726 | 5.133 | 6.283 |
| R5/R7 | −2.989 | −2.855 | −1.738 | −1.732 |
| R6/R7 | 1.749 | 1.768 | 2.674 | 2.691 |

The example imaging lens system according to the one or more embodiments may be changed to other forms. As an example, the imaging lens system according to the one or more embodiments may include one or more optical path conversion devices.

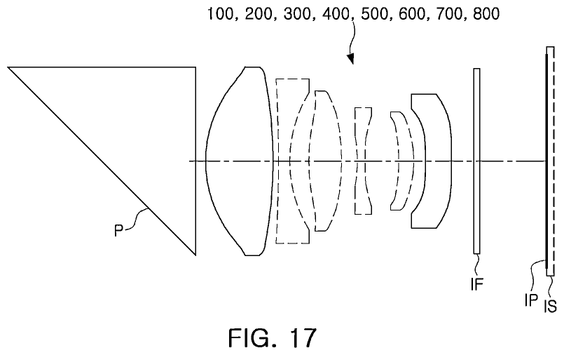

As a specific example, the example imaging lens system (100, 200, 300, 400, 500, 600, 700, and 800) according to the first to eighth embodiments may further include an optical path conversion device (P) as illustrated in FIG. 17. In an example, the optical path conversion device (P) may be in the form of a prism. However, one type of optical path conversion means (P) is limited to a prism. As an example, the optical path conversion device (P) may be configured in the form of a reflector. The optical path conversion device (P) may be disposed on an object side of the foremost lens. However, the placement position of the optical path conversion device (P) is not limited to the object side of the foremost lens. As an example, the optical path conversion device (P) may be disposed on an image side of the rearmost lens. As another example, the optical path conversion device (P) may be disposed on the object side of the foremost lens and the image side of the rearmost lens, respectively.

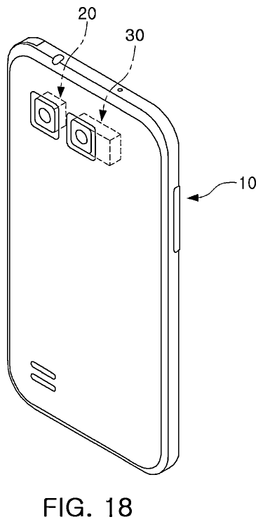

An electronic device according to the one or more embodiments will be described with reference to FIG. 18.

An example electronic device 10 according to the one or more embodiments may include a camera module.

As an example, the electronic device 10 may be a portable terminal including camera modules 20 and 30. However, the form of the electronic device 10 is not limited to a portable terminal. For example, the electronic device 10 may include any portable electronic device such as a laptop or a tablet personal computer (PC), as only examples. The electronic device 10 according to the one or more embodiments may include one or more of an imaging lens systems 100, 200, 300, 400, 500, 600, 700, and 800 according to the first to eighth embodiments. As an example, among the first camera module 20 and the second camera module 30 installed on one side of the electronic device 10 is an imaging lens system 100, 200, 300, 400, 500, 600, 700, and 800 according to the first to eighth embodiments.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An imaging lens system, comprising:
a first lens group comprising one or more lenses; and
a second lens group, comprising one or more lenses and configured to be movable in an optical axis direction,
wherein the first lens group and the second lens group are arranged sequentially from an object side toward an imaging plane, and
wherein the imaging lens system satisfies the following conditional expression:
$$TTL / ( ImgHT * 2 ) < 0.850 ,$$
where TTL is a distance from an object-side surface of a foremost lens disposed closest to an object, to the imaging plane, and ImgHT is a height of the imaging plane.

2. The imaging lens system of claim 1, wherein the foremost lens has a convex image-side surface.

3. The imaging lens system of claim 1, wherein a rear lens in the first lens group disposed closest to the second lens group has a convex image-side surface.

4. The imaging lens system of claim 1, wherein a front lens in the second lens group disposed closest to the first lens group has a concave object-side surface.

5. The imaging lens system of claim 1, wherein a rearmost lens disposed closest to the imaging plane has a concave image-side surface.

6. The imaging lens system of claim 1, wherein:
$$fG 1 / fG 1 F < 1.1 ,$$
where fG1 is a focal length of the first lens group, and fG1F is a focal length of the foremost lens.

7. The imaging lens system of claim 1, wherein:
$$fG 2 / fG 2 F < 1. ,$$
where fG2 is a focal length of the second lens group, and fG2F is a focal length of a lens disposed closest to the object in the second lens group.

8. The imaging lens system of claim 1, wherein:
$$fG 1 / f < 0.550 ,$$
where fG1 is a focal length of the first lens group, and f is a focal length of the imaging lens system.

9. An imaging lens system, comprising:
a first lens, a second lens, a third lens, a fourth lens, a fifth lens, and a sixth lens, sequentially arranged from an object side toward an imaging plane,
wherein the first lens has a convex image-side surface, and
wherein −1.2<f1/f4<−0.40,
where f1 is a focal length of the first lens and f4 is a focal length of the fourth lens.

10. The imaging lens system of claim 9, wherein the first lens has a convex object-side surface.

11. The imaging lens system of claim 9, wherein the second lens has a concave image-side surface.

12. The imaging lens system of claim 9, wherein the third lens has a convex object-side surface.

13. The imaging lens system of claim 9, wherein the fourth lens has a concave object-side surface.

14. The imaging lens system of claim 9, wherein the fifth lens has a convex image-side surface.

15. The imaging lens system of claim 9, wherein the imaging lens system further comprises a seventh lens disposed on an image side of the sixth lens.

16. The imaging lens system of claim 15, wherein the seventh lens has a concave image-side surface.

17. An electronic device, comprising:
an imaging lens system comprising:
a first lens, a second lens, a third lens, a fourth lens, a fifth lens, and a sixth lens, sequentially arranged from an object side toward an imaging plane,
wherein the imaging lens system satisfies the following conditional expression:
$$TTL / ( ImgHT * 2 ) < 0.850 ,$$
where TTL is a distance from an object-side surface of a foremost lens disposed closest to an object, to the imaging plane, and ImgHT is a height of the imaging plane.

18. The electronic device of claim 17, wherein the imaging lens system further comprises a seventh lens disposed on an image side of the sixth lens.
